(19) United States
(12) Patent Application Publication
(10) Pub. No.: US 2025/0153485 A1
(43) Pub. Date: May 15, 2025

(54) PRINTER, CONTROL METHOD, AND NON-TRANSITORY COMPUTER-READABLE MEDIUM STORING COMPUTER-READABLE INSTRUCTIONS

(71) Applicant: BROTHER KOGYO KABUSHIKI KAISHA, Nagoya (JP)

(72) Inventor: Daisuke KUNO, Kiyosu (JP)

(21) Appl. No.: 18/932,177

(22) Filed: Oct. 30, 2024

(30) Foreign Application Priority Data
Nov. 9, 2023 (JP) 2023-191776

(51) Int. Cl. B41J 2/175; B41J 2/165

(52) U.S. Cl. CPC B41J 2/17596; B41J 2/16507; B41J 2/17503; B41J 2/17563; B41J 2/17566; B41J 2202/05

(57) ABSTRACT

A printer has a nozzle surface including a first nozzle and a second nozzle, a first container storing a first discharge liquid, and a second container storing a second discharge liquid. A processor of the printer controls one or both of a first valve provided in a first flow path and a second valve provided in a second flow path closed when a holding state in which a cap holds a holding liquid between the cap and the nozzle surface, and a non-circulating in which neither a first circulating state nor a second circulating state is establish state are established. The first circulating state is one in which the first discharge liquid circulates via the first flow path. The second circulating state is one in which the second discharge liquid circulates via the second flow path is established.

### REFERENCE TO RELATED APPLICATIONS

This application claims priority from Japanese Patent Application No. 2023-191776 filed on Nov. 9, 2023. The entire content of the priority application is incorporated herein by reference.

### BACKGROUND ART

A liquid discharge device is provided with a discharge head, a container, and a cap. The discharge head ejects a discharge liquid from each of a plurality of nozzles. The container stores the discharge liquid and is connected to each of the plurality of nozzles. The cap forms a holding space around the plurality of nozzles and holds a holding liquid within the holding space.

### SUMMARY

In the liquid discharge device, it is conceivable to provide, as the container, a first container connecting to any one of the plurality of nozzles, and a second container connecting to another one of the plurality of nozzles. In this case, while the holding liquid is held in the holding space, the first container and the second container are connected together via the holding space such that liquid can travel between them. Therefore, if a pressure difference occurs between the first container and the second container, holding liquid can enter the container with the lower pressure through the nozzle.

Embodiments of the broad principles derived herein provide a printer, a control method, and a non-transitory computer-readable medium storing computer-readable instructions that contribute to inhibiting holding liquid from entering the container.

A first aspect of the present disclosure relates to a printer. The printer is provided with a nozzle surface including a first nozzle and a second nozzle. The printer is configured to discharge a first discharge liquid from the first nozzle and discharge a second discharge liquid from the second nozzle. The printer includes a first container, a first flow path, a first valve, a second container, a second flow path, a second valve, a cap, a processor, and a memory. The first container is configured to store the first discharge liquid. The first flow path connects the first container to the first nozzle. The first valve is provided in the first flow path. The second container is configured to store the second discharge liquid. The second flow path connects the second container to the second nozzle. The second valve is provided in the second flow path. The cap is configured to form a holding space between the cap and the nozzle surface by surrounding the first nozzle and the second nozzle and contacting the nozzle surface. The cap is configured to hold, in the holding space, a holding liquid. The holding liquid includes at least one of the first discharge liquid, the second discharge liquid, or a cleaning liquid. The memory stores computer-readable instructions that, when executed by the processor, instruct the processor to perform a process including controlling one or both of the first valve and the second valve closed when a holding state and a non-circulating state are established. The holding state is a state in which the cap holds the holding liquid inside the holding space. The non-circulating state is a state in which neither a first circulating state nor a second circulating state is establish. The first circulating state is a state in which the first discharge liquid circulates via the first flow path. The second circulating state is a state in which the second discharge liquid circulates via the second flow path is established.

According to the first aspect, in the holding and non-circulating state, one or both of the first valve and the second valve are controlled to be closed. Thus, even if there is a pressure difference between the first container and the second container, the pressure difference between the first container and the second container is unlikely to affect the pressure difference between the first nozzle and the second nozzle. As a result, the printer contributes to reducing the possibility of the holding liquid entering the first container and the second container.

A second aspect of the present disclosure relates to a control method of a printer. The printer is provided with a nozzle surface including a first nozzle and a second nozzle. The printer is configured to discharge a first discharge liquid from the first nozzle and discharge a second discharge liquid from the second nozzle. The printer includes a first container, a first flow path, a first valve, a second container, a second flow path, a second valve, and a cap. The first container is configured to store the first discharge liquid. The first flow path connects the first container to the first nozzle. The first valve is provided in the first flow path. The second container is configured to store the second discharge liquid. The second flow path connects the second container to the second nozzle. The second valve is provided in the second flow path. The cap is configured to form a holding space between the cap and the nozzle surface by surrounding the first nozzle and the second nozzle and contacting the nozzle surface. The cap is configured to hold, in the holding space, a holding liquid. The holding liquid includes at least one of the first discharge liquid, the second discharge liquid, or a cleaning liquid. The control method includes controlling one or both of the first valve and the second valve closed when a holding state and a non-circulating state are established. The holding state is a state in which the cap holds the holding liquid inside the holding space. The non-circulating state is a state in which neither a first circulating state nor a second circulating state is establish. The first circulating state is a state in which the first discharge liquid circulates via the first flow path. The second circulating state is a state in which the second discharge liquid circulates via the second flow path is established.

The second aspect contributes to reducing the possibility of the holding liquid entering the first container and the second container in the same way as the first aspect.

A third aspect of the present disclosure relates to a non-transitory computer-readable medium storing computer-readable instructions that, when executed by a computer for controlling a printer, instruct the computer to perform a process. The printer is provided with a nozzle surface including a first nozzle and a second nozzle. The printer is configured to discharge a first discharge liquid from the first nozzle and discharge a second discharge liquid from the second nozzle. The printer includes a first container, a first flow path, a first valve, a second container, a second flow path, a second valve, and a cap. The first container is configured to store the first discharge liquid. The first flow path connects the first container to the first nozzle. The first valve is provided in the first flow path. The second container is configured to store the second discharge liquid. The second flow path connects the second container to the second nozzle. The second valve is provided in the second flow path. The cap is configured to form a holding space between the cap and the nozzle surface by surrounding the first nozzle and the second nozzle and contacting the nozzle surface. The cap is configured to hold, in the holding space, a holding liquid. The holding liquid includes at least one of the first discharge liquid, the second discharge liquid, or a cleaning liquid. The process includes controlling one or both of the first valve and the second valve closed when a holding state and a non-circulating state are established. The holding state is a state in which the cap holds the holding liquid inside the holding space. The non-circulating state is a state in which neither a first circulating state nor a second circulating state is establish. The first circulating state is a state in which the first discharge liquid circulates via the first flow path. The second circulating state is a state in which the second discharge liquid circulates via the second flow path is established.

The third aspect contributes to reducing the possibility of the holding liquid entering the first container and the second container in the same way as the first aspect.

### BRIEF DESCRIPTION OF DRAWINGS

FIG. 1 is a perspective view of a printer.

FIG. 2 is a perspective view of a head.

FIG. 3 is a cross-sectional view taken along line III-III shown in FIG. 1.

FIG. 4 is a flow path configuration diagram of the printer.

FIG. 5 is a block diagram showing an electrical configuration of a printer.

FIG. 6 is a flowchart of main processing.

FIG. 7 is a flowchart of end-of-work processing.

FIG. 8 is a flowchart of circulation processing.

FIG. 9 is a flowchart of first circulation processing.

FIG. 10 is a flowchart showing the continuation of the first circulation processing shown in FIG. 9.

FIG. 11 is a flowchart of second circulation processing.

FIG. 12 is a flowchart of de-wetting processing.

FIG. 13 is a flowchart of valve closing processing.

### DESCRIPTION

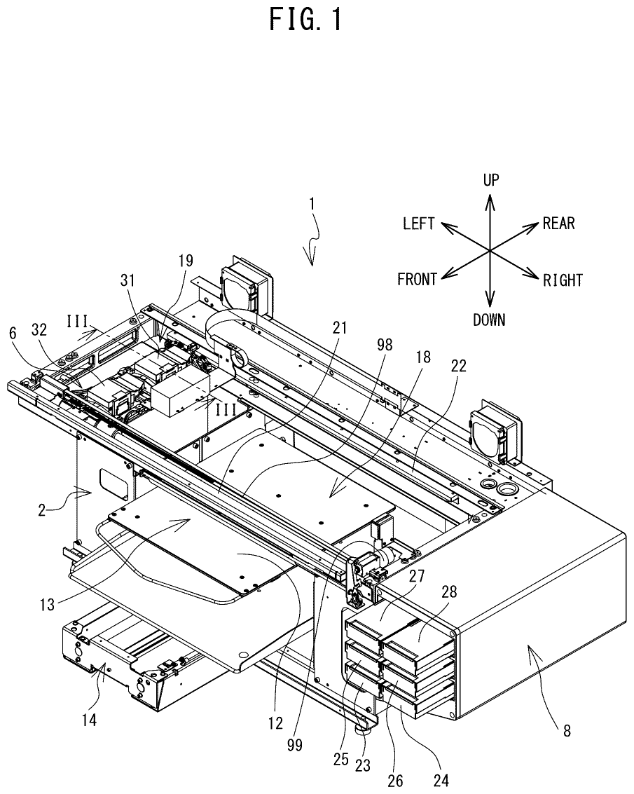

A printer 1 related to one embodiment of the present disclosure will be described with reference to the drawings. The directions of up, down, lower left, upper right, lower right, and upper left in FIG. 1 correspond to the upper side, lower side, front, rear, right, and left, respectively, of the printer 1. The up-down direction in FIG. 1 is the vertical direction. In the present embodiment, the mechanical elements in the drawings are shown at actual scale.

The printer 1 shown in FIG. 1 is an inkjet printer, and performs printing by discharging ink onto a print medium. The print medium is a cloth, paper, or the like, and is a T-shirt, for example. The printer 1 can print a color image on the print medium using five colors of ink, i.e., white, black, yellow, cyan, and magenta.

Hereinafter, of the five colors of ink, the white-colored ink will be referred to as “white ink”. When collectively referring to, of the five colors of ink, the other four colors of ink, i.e., black, cyan, yellow, and magenta, or when neither is specified, they will be referred to as “color ink”. When collectively referring to the white ink and the color ink, or when neither is specified, they will simply be referred to as “ink”. The white ink is used for printing as a white part of an image or as a base for the color ink. The color ink is used for printing a color image and is discharged directly onto the print medium or onto a base of white ink.

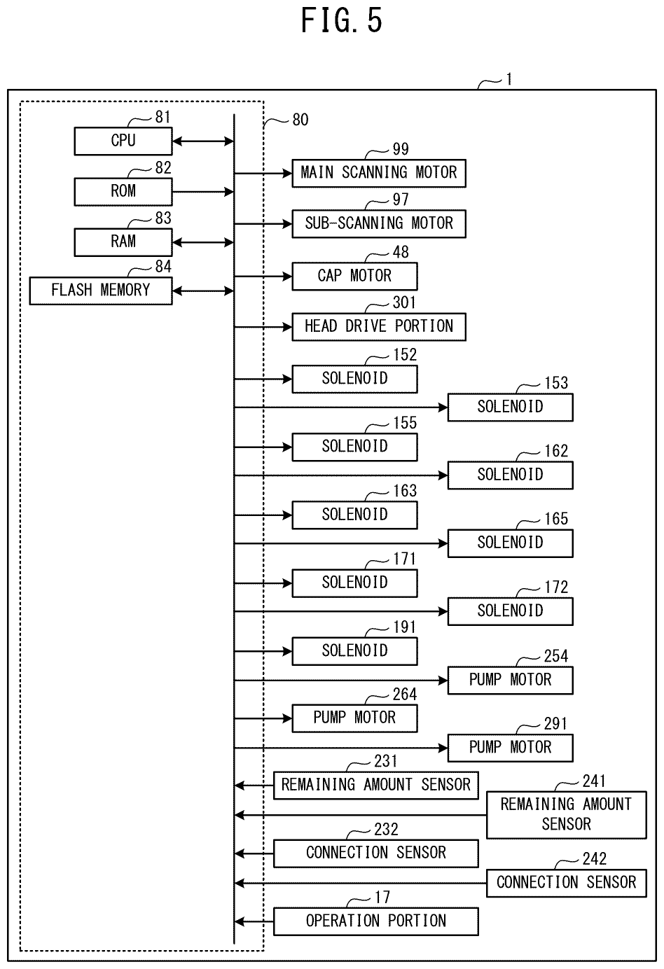

A mechanical configuration of the printer 1 will be explained with reference to FIG. 1 to FIG. 3. As shown in FIG. 1, the printer 1 is provided with a frame body 2, a platen 12, and mounting portion 8. The frame body 2 is configured in a lattice shape by a plurality of plates and a plurality of shafts extending in the front-rear direction, the left-right direction, and the up-down direction. An opening 13 is formed in the frame body 2. The opening 13 is positioned in a central portion of the frame body 2 in a front view, and extends from the front end of the frame body 2 toward the rear. The platen 12 is disposed inside the opening 13 in a front view. The platen 12 has a plate shape, and extends in the front-rear direction and the left-right direction. The print medium is placed on the platen 12. The platen 12 is supported, from below, by a support portion 14. The support portion 14 is fixed to the frame body 2 inside the opening 13. The support portion 14 includes a shaft, and extends in the front-rear direction. The platen 12 moves in the front-rear direction along the support portion 14 as a result of being driven by a sub-scanning motor 97 shown in FIG. 5. Thus, the front-rear direction of the present embodiment is the sub-scanning direction.

A pair of guide shafts 21 and 22 are fixed to the upper end of the frame body 2. The guide shaft 21 is disposed at a front end portion of the frame body 2 and extends in the left-right direction from the left end to the right end of the frame body 2. The guide shaft 22 is disposed substantially at the center of the frame body 2 in the front-rear direction, and is positioned further to the rear than the guide shaft 21. The guide shaft 22 extends in the left-right direction from the left end to the right end of the frame body 2. The guide shafts 21 and 22 support the carriage 6. The carriage 6 has a plate shape and extends in the front-rear direction and the left-right direction. The carriage 6 extends from the guide shaft 21 to the guide shaft 22.

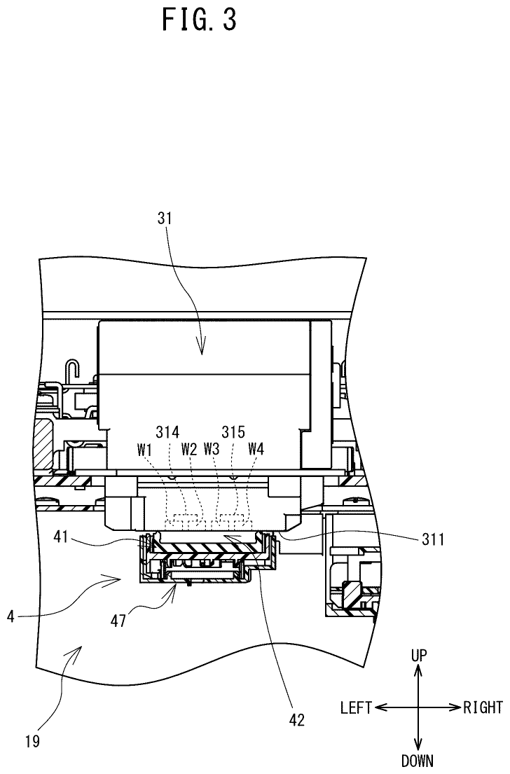

A drive belt 98 is connected to the carriage 6. The drive belt 98 is provided on the guide shaft 21 and extends in the left-right direction. The drive belt 98 is connected to a main scanning motor 99. The main scanning motor 99 is provided on the right end portion of the guide shaft 21. Driving the main scanning motor 99 causes the drive belt 98 to move the carriage 6 in the left-right direction along the guide shaft 21 and the guide shaft 22. Therefore, in the present embodiment, the left-right direction is the main scanning direction. FIG. 1 and FIG. 3 show a state in which the carriage 6 is positioned on the left end of the moving range. Heads 31 and 32 are mounted on the carriage 6. The head 31 is positioned at the rear portion of the carriage 6 and discharges the white ink. The head 32 is aligned forward to the head 31 and discharges the color inks.

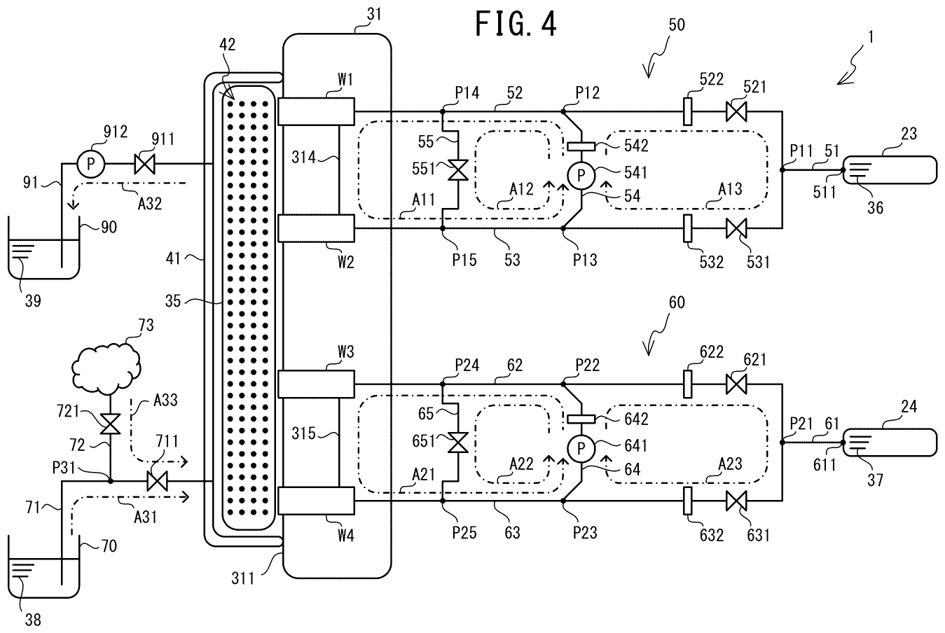

The mounting portion 8 is box-shaped and open at the front, and is fixed to the right surface of the frame body 2. A plurality of ink cartridges 23, 24, 25, 26, 27, and 28 are mounted to the mounting portion 8. Each of the ink cartridges 23 to 28 is a container that can be replaced in the mounting portion 8. The ink cartridge 23 stores white ink 36 (refer to FIG. 4) to be supplied to the head 31. The ink cartridge 24 stores white ink 37 (refer to FIG. 4) to be supplied to the head 31. The ink cartridges 25 to 28 store black, cyan, yellow, and magenta ink (not shown in the drawings), respectively, to be supplied to the head 32.

According to the above-described configuration, the heads 31 and 32 move in the left-right direction together with the carriage 6. A region in which a movement path of the platen 12 in the left-right direction overlaps, in the up-down direction, with a movement path of the heads 31 and 32 in the front-rear direction is referred to as a “printing region 18.” Of the movement path of the heads 31 and 32, a region that is further to the left than the movement path of the platen 12 is referred to as a “non-printing region 19.” When the heads 31 and 32 and the platen 12 are positioned in the printing region 18, the platen 12 and each of the heads 31 and 32 face each other in the up-down direction.

In the printing region 18, the printer 1 conveys a print medium relative to the heads 31 and 32 in the front-rear direction and the left-right direction, by moving the platen 12 in the front-rear direction (the sub-scanning direction) by the driving of the sub-scanning motor 97 shown in FIG. 5, and by moving the carriage 6 in the left-right direction (the main scanning direction) by the driving of the main scanning motor 99.

An operation in which the carriage 6 moves in the left-right direction while discharging the white ink from the head 31 or discharging the color inks from the head 32 is referred to as “discharge scanning.” The printer 1 performs printing on the print medium by repeating the discharge scanning and the movement of the platen 12 in the front-rear direction. For example, the printer 1 forms a base image on the print medium by discharging the white ink from the head 31 in the discharge scanning. The printer 1 prints a color image by discharging the color inks from the head 32 onto the base image formed on the print medium in the discharge scanning.

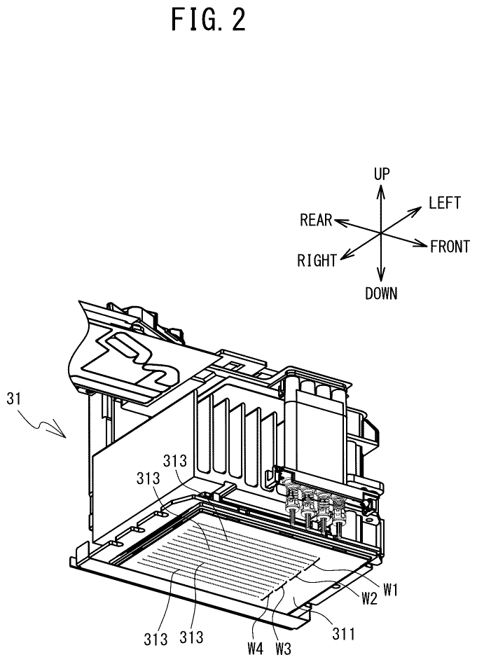

As shown in FIG. 2, the head 31 has a cuboid shape. A nozzle surface 311 is provided on a lower surface of the head 31. The nozzle surface 311 has a planar shape and extends in the front-rear and left-right directions. The nozzle surface 311 is positioned above the platen 12 shown in FIG. 1, and is exposed from below through an opening provided in the carriage 6 shown in FIG. 1. A plurality of nozzles 313 are provided on the nozzle surface 311. The plurality of nozzles 313 are openings that discharge ink downward. The plurality of nozzles 313 are lined up in a row in the front-rear direction, with a plurality of rows lined up in the left-right direction. The plurality of nozzles 313 are divided into nozzle groups W1, W2, W3, and W4. The nozzle groups W1, W2, W3, and W4 are arranged in the order of nozzle group W1, nozzle group W2, nozzle group W3, and nozzle group W4 from left to right.

The nozzle group W1 is a plurality of nozzle rows to which the ink cartridge 23 is connected via a flow path 52 (refer to FIG. 4), to be described later. The nozzle group W2 is a plurality of nozzle rows to which the ink cartridge 23 is connected via a flow path 53 (refer to FIG. 4), to be described later. Therefore, the nozzle group W1 and the nozzle group W2 both discharge the white ink 36 supplied from the ink cartridge 23. The nozzle group W3 is a plurality of nozzle rows to which the ink cartridge 24 is connected via a flow path 62 (refer to FIG. 4), to be described later. The nozzle group W4 is a plurality of nozzle rows to which the ink cartridge 24 is connected via a flow path 63 (refer to FIG. 4), to be described later. Therefore, the nozzle group W3 and the nozzle group W4 both discharge the white ink 37 supplied from the ink cartridge 24.

Communication paths 314 and 315 shown in FIG. 3 and FIG. 4 are provided in the head 31. The communication paths 314 and 315 are both formed by a wall inside the head 31. For example, the communication paths 314 and 315 are both formed by a groove formed in a layer above the nozzle surface 311 in the laminate sheet that constitutes the nozzle surface 311.

One end of the communication path 314 is connected to the nozzle group W1. The other end of the communication path 314 is connected to the nozzle group W2. As a result, the nozzle group W1 and the nozzle group W2 are connected together via the communication path 314. One end of the communication path 315 is connected to the nozzle group W3. The other end of the communication path 315 is connected to the nozzle group W4. As a result, the nozzle group W3 and the nozzle group W4 are connected together via the communication path 315.

Note that the communication path 314 may be a flow path that is connected to a first common pressure chamber connected to the nozzle group W1 and to the first common pressure chamber connected to the nozzle group W2. In other words, the communication path 314 may connect the nozzle group W1 and the nozzle group W2 together via the first common pressure chamber. The communication path 315 may be a flow path that is connected to a second common pressure chamber connected to the nozzle group W3 and to the second common pressure chamber connected to the nozzle group W4. In other words, the communication path 315 may connect the nozzle group W3 and the nozzle group W4 together via the second common pressure chamber.

Although not shown in the drawings, a nozzle surface is provided on the lower surface of the head 32, and a plurality of nozzles are provided on the nozzle surface, similar to the configuration of the head 31. The head 32 discharges color ink downward from the plurality of nozzles. Note that the head 32 need not be provided with communication paths for connecting together nozzle groups that discharge different colored color ink.

As shown in FIG. 3, the printer 1 is provided with a cap mechanism 4. The cap mechanism 4 is provided in the non-printing region 19 (refer to FIG. 1). The cap mechanism 4 is provided with a cap support portion 47, a cap 41, and one more cap (not shown in the drawings). The cap support portion 47 has a plate shape and extends in the front-rear direction and the left-right direction. The cap support portion 47 moves in the up-down direction as a result of the driving of a cap motor 48 shown in FIG. 5. The cap 41 and the one more cap are fixed to an upper surface of the cap support portion 47. The cap 41 and the one more cap are positioned in the same position as the heads 31 and 32, respectively, in the front-rear direction. The cap 41 and the one more cap are configured by an elastic body, such as rubber or the like, for example, and are open upward.

According to the above-described configuration, when the carriage 6 moves to the left end of a movement range in the non-printing region 19, the nozzle surface 311 of the head 31 and the nozzle surface of the head 32 are positioned above the cap 41 and the one more cap, respectively, and face the cap 41 and the one more cap in the up-down direction. A position of the carriage 6 in which the nozzle surface 311 of the head 31 and the nozzle surface of the head 32 face the cap 41 and the one more cap, respectively, in the up-down direction is referred to as a “cap position.”

When the cap support portion 47 moves upward in a state in which the carriage 6 is at the cap position, the cap 41 surrounds all of the nozzle groups W1, W2, W3, and W4 in the head 31, and contacts the nozzle surface 311 from below. As a result, a holding space 42 is formed between the cap 41 and the nozzle surface 311. The holding space 42 is a space that is surrounded by the cap 41 and the nozzle surface 311. Hereinafter, a state in which the cap 41 contacts the nozzle surface 311 of the head 31 from below to form the holding space 42 is referred to as a “capping state” (refer to FIG. 3 and FIG. 4). A state in which the cap 41 is separated downward from the nozzle surface 311 of the head 31 is referred to as an “uncapping state” (refer to FIG. 2).

During a period in which the printing is not performed, the printer 1 places the cap 41 in the capping state in order to suppress the drying out of the ink in the head 31. In the capping state of the present embodiment, the cap 41 contacts the nozzle surface 311 to an extent that a pressure difference between inside (holding space 42) and outside (the atmosphere) the cap 41 can be maintained. For example, when all of the plurality of nozzles 313 are cut off from the atmosphere, the holding space 42 becomes an airtight space surrounded by the cap 41 and the nozzle surface 311. The holding space 42 is a space for holding a holding liquid 35 shown in FIG. 4. The holding liquid 35 includes at least one of the white ink 36, the white ink 37, or a cleaning liquid 38 shown in FIG. 4. Hereinafter, a state in which the holding liquid 35 is held in the holding space 42 is referred to a “holding state.” When the holding space 42 is filled with the holding liquid 35, the holding liquid 35 contacts the nozzle surface 311. In the holding state, a state in which the holding space 42 is filled with the holding liquid 35 and the holding liquid 35 is contacting the nozzle surface 311 is referred to as a “wetted state.”

Similar to the cap 41, when the cap supporting portion 47 moves upward in a state in which the carriage 6 is positioned at the cap position, the one other cap contacts the nozzle surface of the head 32 from below. A holding space (not shown in the drawings) is consequently formed between the one other cap and the nozzle surface of the head 32.

The flow path configuration in the printer 1 will now be described with reference to FIG. 4. In the present embodiment, each of the flow paths is formed by a tube and is flexible. The printer 1 is provided with flow paths 50 and 60. The flow path 50 is a flow path of the white ink 36 and connects the ink cartridge 23 and each of the nozzle groups W1 and W2 together. The flow path 60 is a flow path of the white ink 37 and connects the ink cartridge 24 and each of the nozzle groups W3 and W4 together. Note that, although not shown in the drawings, a sub-tank may be provided as an intermediate buffer of the white inks 36 and 37, in each of the flow paths 50 and 60.

The flow path 50 includes flow paths 51, 52, 53, 54, and 55. A connection port 511 is provided at one end of the flow path 51. The connection port 511 is arranged inside the mounting portion 8 shown in FIG. 1. In a state in which the ink cartridge 23 is mounted to the mounting portion 8, the ink cartridge 23 is connected to the connection port 511. Hereinafter, when the ink cartridge 23 is in a state connected to the flow path 51 via the connection port 511, “the ink cartridge 23 is in a connected state.” The flow path 51 extends from the connection port 511 (ink cartridge 23) to a point P11, and connects to each of the flow paths 52 and 53 at the point P11. In other words, the flow path 51 branches into the flow path 52 and the flow path 53 at the point P11.

The flow path 52 extends from the point P11 to the nozzle group W1, and connects to the nozzle group W1. Thus, the flow path 52 connects the ink cartridge 23 and the nozzle group W1 together via the flow path 51. The flow path 53 extends from the point P11 to the nozzle group W2, and connects to the nozzle group W2. Thus, the flow path 53 connects the ink cartridge 23 and the nozzle group W2 together via the flow path 51. A point P12 is located between the point P11 and the nozzle group W1. A point P13 is located between the point P11 and the nozzle group W2. The flow path 54 extends from the point P12 to the point P13, and connects to the flow path 52 at the point P12, and connects to the flow path 53 at the point P13. A point P14 is located between the point P12 and the nozzle group W1. A point P15 is located between the point P13 and the nozzle group W2. The flow path 55 extends from the point P14 to the point P15, and connects to the flow path 52 at the point P14, and connects to the flow path 53 at the point P15.

A valve 521 and a filter 522 are provided in the flow path 52. The valve 521 and the filter 522 are both positioned between the point P11 and the point P12. In the present embodiment, the valve 521 and the filter 522 are arranged in the order of the valve 521 and the filter 522 from the point P11 toward the point P12.

In a closed state, the valve 521 closes off the flow path 52 between the point P11 and the point P12. In an open state, the valve 521 opens the flow path 52 between the point P11 and the point P12. The valve 521 is not limited to a specific type, and may be, for example, a diaphragm valve that opens and closes the flow path using an elastic diaphragm, or a tube valve that opens and closes the flow path by squeezing the tube. Note that the type of each valve 531, 551, 621, 631, and 651, described later, may be different from that of the valve 521, but in the present embodiment, it is the same as that of the valve 521. The filter 522 filters the white ink 36 that passes through the filter 522. The filter 522 is not limited to a specific type, and may be made of nonwoven fabric, woven fabric, resin film, or porous metal pieces, for example. Note that the type of each filter 532, 542, 622, 632, and 642, described later, may be different from that of the filter 522, but in the present embodiment, it is the same as that of the filter 522.

The valve 531 and the filter 532 are provided in the flow path 53. The valve 531 and the filter 532 are both positioned between the point P11 and the point P13. In the present embodiment, the valve 531 and the filter 532 are arranged in the order of the valve 531 and the filter 532 from the point P11 toward the point P13. In a closed state, the valve 531 closes off the flow path 53 between the point P11 and the point P13. In an open state, the valve 531 opens the flow path 53 between the point P11 and the point P13. The filter 532 filters the white ink 36 that passes through the filter 532.

A pump 541 and a filter 542 are provided in the flow path 54. In the present embodiment, the pump 541 and the filter 542 are arranged in the order of the pump 541 and the filter 542 from the point P13 toward the point P12. Driving the pump 541 causes the white ink 36 to be sent from the point P13 toward the point P12. The filter 542 filters the white ink 36 that passes through the filter 542. The valve 551 is provided in the flow path 55. In a closed state, the valve 551 closes off the flow path 55. In an open state, the valve 551 opens the flow path 55.

The configuration of the flow path 60 differs from that of the flow path 50 in that the connection destinations are the ink cartridge 24 and the nozzle groups W3 and W4 instead of the ink cartridge 23 and the nozzle groups W1 and W2. The flow path 60 includes flow paths 61, 62, 63, 64, and 65. A connection port 611 is provided at one end of the flow path 61. The connection port 611 is arranged inside the mounting portion 8 shown in FIG. 1. The ink cartridge 24 is connected to the connection port 611 while the ink cartridge 24 is mounted to the mounting portion 8. Hereinafter, when the ink cartridge 24 is in a state connected to the flow path 61 via the connection port 611, “the ink cartridge 23 is in a connected state.” The flow path 61 extends from the connection port 611 (ink cartridge 24) to a point P21, and connects to both of the flow paths 62 and 63 at the point P21. In other words, the flow path 61 branches into the flow path 62 and the flow path 63 at the point P21.

The flow path 62 extends from the point P21 to the nozzle group W3 and connects to the nozzle group W3. Thus, the flow path 62 connects the ink cartridge 24 and the nozzle group W3 together via the flow path 61. The flow path 63 extends from the point P21 to the nozzle group W4 and connects to the nozzle group W4. Therefore, the flow path 63 connects the ink cartridge 24 and the nozzle group W4 together via the flow path 61. A point P22 is located between the point P21 and the nozzle group W3. A point P23 is located between the P21 and the nozzle group W4. The flow path 64 extends from the point P22 to the point P23 and connects to the flow path 62 at the point P22 and connects to the flow path 63 at the point P23. A point P24 is located between the point P22 and the nozzle group W3. A point P25 is located between the point P23 and the nozzle group W4. The flow path 65 extends from the point P24 to the point P25 and connects to the flow path 62 at the point P24 and connects to the flow path 63 at the point P25.

A valve 621 and a filter 622 are provided in the flow path 62. The valve 621 and the filter 622 are both positioned between the point P21 and the point P22. In the present embodiment, the valve 621 and the filter 622 are arranged in the order of the valve 621 and the filter 622 from the point P21 toward the point P22. In a closed state, the valve 621 closes off the flow path 62 between the point P21 and the point P22. In an open state, the valve 621 opens the flow path 62 between the point P21 and the P22. The filter 622 filters the white ink 37 that passes through the filter 622.

A valve 631 and a filter 632 are provided in the flow path 63. The valve 631 and the filter 632 are both positioned between the point P21 and the point P23. In the present embodiment, the valve 631 and the filter 632 are arranged in the order of the valve 631 and the filter 632 from the point P21 toward the point P23. In a closed state, the valve 631 closes off the flow path 63 between the point P21 and the point P23. In an open state, the valve 631 opens the flow path 63 between the point P21 and the P23. The filter 632 filters the white ink 37 that passes through the filter 632.

A pump 641 and a filter 642 are provided in the flow path 64. In the present embodiment, the pump 641 and the filter 642 are arranged in the order of the pump 641 and the filter 642 from the point P23 toward the point P22. Driving the pump 641 sends the white ink 37 from the point P23 toward the point P22. The filter 642 filters the white ink 37 that passes through the filter 642. A valve 651 is provided in the flow path 65. In a closed state, the valve 651 closes off the flow path 65. In an open state, the valve 651 opens the flow path 65.

According to the above-described configuration, during printing, for example, in the flow path 50, the pair of valves 521 and 531 are open and the driving of the pump 541 is stopped. In this case, the white ink 36 flows from the ink cartridge 23 through the flow path 51 as a result of external pressure acting on the ink cartridge 23. The white ink 36 branches off to the flow path 52 and the flow path 53 at the point P11, and flows toward the nozzle group W1 via the flow path 52, and flows toward the nozzle group W2 via the flow path 53. During printing, in the flow path 60, the pair of valves 621 and 631 are open and the driving of the pump 641 is stopped. In this case, the white ink 37 flows from the ink cartridge 24 through the flow path 61 as a result of external pressure acting on the ink cartridge 24. The white ink 37 branches off to the flow path 62 and the flow path 63 at the point P21, and flows toward the nozzle group W3 via the flow path 62 and flows toward the nozzle group W4 via the flow path 63.

The printer 1 is provided with a cleaning liquid tank 70 and flow paths 71 and 72. The cleaning liquid tank 70 is a container, and stores the cleaning liquid 38 for cleaning the nozzle surface 311 and the like. One end of the flow path 71 is connected to the cleaning liquid tank 70. The other end of the flow path 71 is connected to the cap 41 (holding space 42). Thus, the flow path 71 connects the cleaning liquid tank 70 and the cap 41 (holding space 42) together. A valve 711 is provided in the flow path 71. The valve 711 is positioned between a point P31 and the other end (cap 41) of the flow path 71. In a closed state, the valve 711 closes off the flow path 71 between the point P31 and the other end (cap 41) of the flow path 71. In an open state, the valve 711 opens the flow path 71 between the point P31 and the other end (cap 41) of the flow path 71. One end of the flow path 72 connects to the flow path 71 at the point P31. The other end of the flow path 72 is open to an atmosphere 73. A valve 721 is provided in the flow path 72. In a closed state, the valve 721 closes off the flow path 72. In an open state, the valve 721 opens the flow path 72.

The printer 1 is provided with a waste tank 90 and a flow path 91. The waste tank 90 is a container that receives the holding liquid 35, i.e., waste liquid 39, discharged from the holding space 42. One end of the flow path 91 connects to the cap 41 (holding space 42). The other end of the flow path 91 connects to the waste tank 90. Thus, the flow path 91 connects the waste tank 90 and the cap 41 (holding space 42) together. A valve 911 and a pump 912 are provided in the flow path 91. The valve 911 and the pump 912 are arranged in the order of the valve 911 and the pump 912 from the cap 41 toward the waste tank 90. In a closed state, the valve 911 closes off the flow path 91. In an open state, the valve 911 opens the flow path 91. Driving the pump 912 causes the holding liquid 35 or air to be drawn in from the holding space 42 and the drawn in holding liquid 35 or air to be sent to the waste tank 90 via the flow path 91.

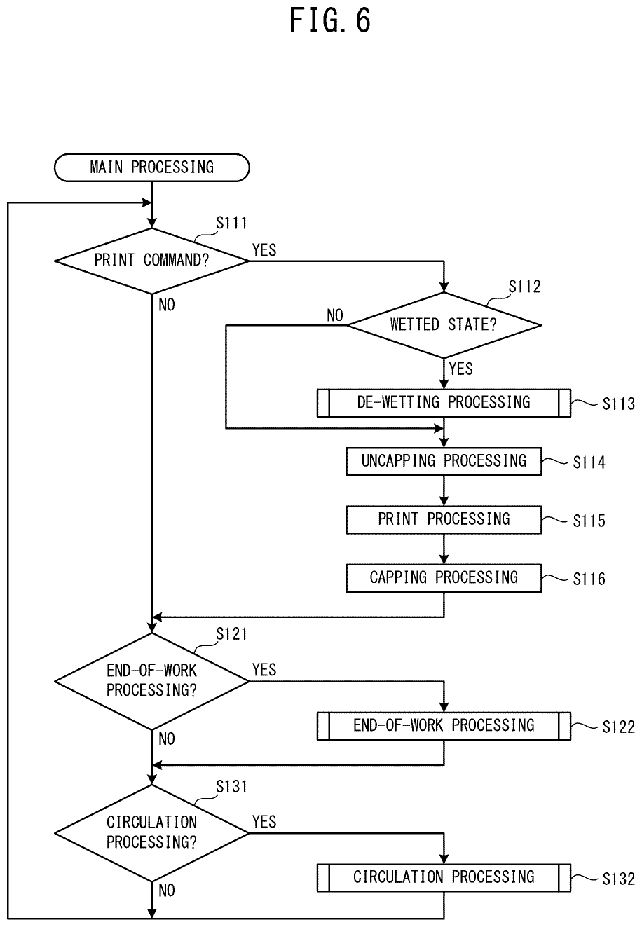

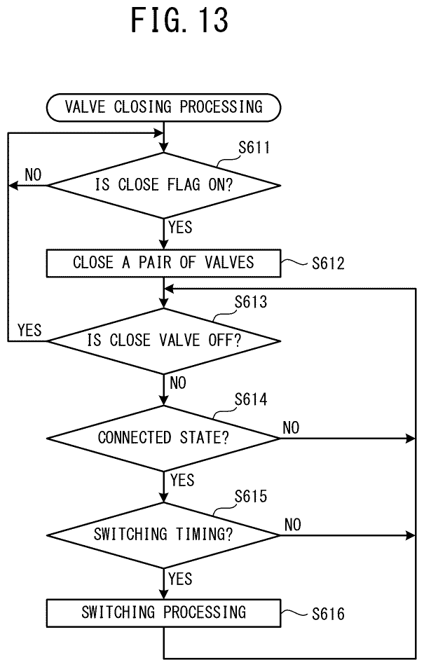

The electrical configuration of the printer 1 will be described with reference to FIG. 5. The printer 1 is provided with a control board 80. A CPU 81, ROM 82, RAM 83, and flash memory 84 are provided on the control board 80. The CPU 81 controls the printer 1 and is electrically connected to the ROM 82, the RAM 83, and the flash memory 84. The ROM 82 stores a control program used for the CPU 81 to control operations of the printer 1, and various pieces of information and the like needed by the CPU 81 when executing various programs. The control program includes a main program for executing main processing (refer to FIG. 6), to be described later, and a closing processing program for executing valve closing processing (refer to FIG. 13), to be described later. The RAM 83 temporarily stores various data used by the control program. The flash memory 84 is non-volatile, and stores print data for performing the printing, and the like.

The main scanning motor 99, the sub-scanning motor 97, the cap motor 48, a head drive portion 301, solenoids 152, 153, 155, 162, 163, 165, 171, 172, and 191, pump motors 254, 264, and 291, remaining amount sensors 231 and 241, connection sensors 232 and 242, and an operation portion 17 are electrically connected to the CPU 81. The main scanning motor 99, the sub-scanning motor 97, the cap motor 48, the head drive portion 301 and the solenoids 152, 153, 155, 162, 163, 165, 171, 172, and 191, and the pump motors 254, 264, and 291 are driven by control by the CPU 81.

The head drive portion 301 is configured by a piezoelectric element or a heating element, for example, and is provided on each of a plurality of nozzles 313 (refer to FIG. 2) in the head 31. Driving the head drive portion 301 causes the head 31 to selectively discharge the white ink from the plurality of nozzles 313. Although not shown in the drawings, a head drive portion for selectively discharging color ink is also provided in each of a plurality of nozzles of the head 32.

The solenoid 152 is provided on the valve 521. The solenoid 152 opens the valve 521 when the supply of power to the solenoid 152 has been stopped (hereinafter, referred to as “de-energized state) by the CPU 81, and closes the valve 521 when power is supplied to the solenoid 152 (hereinafter, referred to as “energized state”) by the CPU 81. In the same way, the solenoids 153, 155, 162, 163, 165, 171, 172, and 191 are provided on the valves 531, 551, 621, 631, 651, 711, 721, and 911, respectively. In the de-energized state, the solenoids 153, 155, 162, 163, 165, 171, 172, and 191 open the valves 531, 551, 621, 631, 651, 711, 721, and 911, respectively, and in the energized state, the solenoids 153, 155, 162, 163, 165, 171, 172, and 191 close the valves 531, 551, 621, 631, 651, 711, 721, and 911, respectively. The pump motor 254 is provided on the pump 541, and drives the pump 541. In the same way, the pump motors 264 and 291 are provided on the pumps 641 and 912, respectively, and drive the pumps 641 and 912.

The remaining amount sensor 231 is provided on the mounting portion 8 or the ink cartridge 23. The remaining amount sensor 231 detects the remaining amount of the white ink 36 stored in the ink cartridge 23 (hereinafter, referred to as “remaining amount in the ink cartridge 23”) and outputs a signal indicative of the detection result to the CPU 81. The remaining amount sensor 241 is provided on the mounting portion 8 or the ink cartridge 24. The remaining amount sensor 241 detects the remaining amount of the white ink 37 stored in the ink cartridge 24 (hereinafter, referred to as “remaining amount in the ink cartridge 24”) and outputs a signal indicative of the detection result to the CPU 81. The remaining amount sensor 231 is not limited to a specific type, and may be, for example, an optical sensor, a limit switch, a weight sensor, a pressure sensor, or a level sensor. For example, the remaining amount sensor 231 may incrementally detect the remaining amount in the ink cartridge 23 by incrementally detecting, with a plurality of optical sensors, a change in shape of the ink cartridge 23 that follows a change in the remaining amount in the ink cartridge 23. For example, the remaining amount sensor 231 may continuously detect the remaining amount in the ink cartridge 23 with a weight sensor, for example. The remaining amount sensor 241 may be configured like the remaining amount sensor 231.

The connection sensor 232 is provided on the mounting portion 8, the ink cartridge 23 or in the flow path 51. The connection sensor 232 detects whether the ink cartridge 23 is in a connected state, and outputs a signal indicative of the detection result to the CPU 81. The connection sensor 242 is provided on the mounting portion 8, the ink cartridge 24 or in the flow path 61. The connection sensor 242 detects whether the ink cartridge 24 is in a connected state, and outputs a signal indicative of the detection result to the CPU 81. Neither of the connection sensors 232 and 242 are not limited to a specific type, and each may be, for example, an optical sensor, a limit switch, a weight sensor, or a pressure sensor.

The operation portion 17 is, for example, a touch panel, and outputs to the CPU 81 information corresponding to an operation by the user. The user can input, to the printer 1, a print command, for example, to start printing by the printer 1 by operating the operation portion 17.

The main processing will now be described with reference to FIG. 4 and FIG. 6. When the power supply to the printer 1 is turned on, the CPU 81 reads the main program from the ROM 82 and operates the main program to execute the main processing shown in FIG. 6. In the main processing, printing, capping, wetting, circulation, and the like are controlled. In the present embodiment, the main processing is started with the pair of valves 521 and 531 and the pair of valves 621 and 631 open in the capping state shown in FIG. 4.

Hereinafter, a difference between the pressure in the ink cartridge 23 and the pressure in the ink cartridge 24 shown in FIG. 4 is referred to as “cartridge pressure difference.” The cartridge with the smaller pressure, from among the ink cartridges 23 and 24, is referred to as the “smaller pressure cartridge.” A difference between the remaining amount in the ink cartridge 23 and the remaining amount in the ink cartridge 24 is referred to as “cartridge remaining amount difference.” For example, when there is a cartridge remaining amount difference, there may be a cartridge pressure difference.

In the present embodiment, the ink cartridges 23 and 24 each have an ink storage portion and a take-up mechanism. The ink storage portion is flexible. The take-up mechanism reduces the amount of ink remaining in the ink storage portion by taking up the ink storage portion. For example, the take-up mechanism takes up the ink storage portion of the ink cartridge 23 toward the connection port 511 as the remaining amount in the ink cartridge 23 decreases. As a result, the amount that the ink storage portion of the ink cartridge 23 is taken up increases as the remaining amount in the ink cartridge 23 decreases, so the external pressure acting on the ink storage portion of the ink cartridge 23 increases. In the same way, with the ink cartridge 24, the amount that the ink storage portion of the ink cartridge 24 is taken up increases as the remaining amount in the ink cartridge 24 decreases, so the external pressure acting on the ink storage portion of the ink cartridge 24 increases. In this case, the cartridge with the larger remaining amount, from among the ink cartridges 23 and 24, is more likely to be the ink cartridge with the lower pressure. Note that the printer 1 may be provided with a pair of ink cartridges configured such that there is no, or little, change in shape following a change in the remaining amount, instead of the ink cartridges 23 and 24. In this case, the ink cartridge with the smaller remaining amount, from among the pair of ink cartridges, is more likely to be the ink cartridge with the lower pressure.

Hereinafter, for the purpose of explanation, one flow path and another flow path that are not connected to each other will be defined. When one end of the one flow path and one end of the other flow path are separated via a gaseous medium, the liquid discharged from the one flow path via the one end of the one flow path falls through the gaseous medium, and thus cannot enter the other flow path via the one end of the other flow path. In this way, a state in which the liquid discharged from the one flow path via the one end of the one flow path is unable to enter the other flow path via the one end of the other flow path is referred to as an “unconnected so no liquid can travel state.” On the other hand, when there is a liquid medium between the one end of the one flow path and the one end of the other flow path, the liquid discharged from the one flow path via the one end of the one flow path flows through the liquid medium, and is thus may enter the other flow path via the one end of the other flow path. In this way, a state in which the liquid discharged from the one flow path via the one end of the one flow path may enter the other flow path via the one end of the other flow path is referred to as an “connected so liquid can travel state.” Even if the one flow path and the other flow path are not connected together, they can be switched between the unconnected so no liquid can travel state and the connected so liquid can travel state depending on presence or absence of the liquid medium between them.

In the present embodiment, the nozzle groups W1 and W2 are not connected to the nozzle groups W3 and W4. Accordingly, when the nozzle surface 311 shown in FIG. 4 is not in the wetted state, the nozzle groups W1 and W2 are not connected to the nozzle groups W3 and W4, so liquid will not travel. Therefore, when the nozzle surface 311 is not in the wetted state, the white ink 36 will not enter the flow path 60 via the nozzle groups W3 and W4, and the white ink 37 will not enter the flow path 50 via the nozzle groups W1 and W2, regardless of whether there is a pressure difference between the cartridges. On the other hand, as shown in FIG. 4, in the wetted state, the nozzle groups W1 and W2 and the nozzle groups W3 and W4 are connected together via the holding liquid 35, allowing liquid to travel. Therefore, in the wetted state, the flow path 50 and the flow path 60 are connected together via the holding liquid 35, allowing liquid to travel. Note that even if the nozzle surface 311 were not in the wetted state, if the cap 41 is in the holding state, the holding liquid 35 may contact the nozzle groups W1, W2, W3, and W4 due to vibration or the like, so the flow path 50 and the flow path 60 may become connected together via the holding liquid 35, allowing liquid to travel.

When the flow path 50 and the flow path 60 are connected together via the holding liquid 35, allowing liquid to travel, while there is a cartridge pressure difference, the holding liquid 35 may enter the ink cartridge with the lower pressure via the nozzles 313. For example, when the cartridge with the lower pressure is the ink cartridge 23, the holding liquid 35 may enter the flow path 50 via the nozzle groups W1 and W2. For example, when the white ink 37 that constitutes the holding liquid 35 has entered the flow path 50, the white ink 37 that has entered the flow path 50 will be consumed by printing thereafter, so the consumption amount of the white ink 36 due to printing thereafter will decrease. In this case, the white ink 36 in the ink cartridge 23 will become old so the quality of the white ink 36 in the ink cartridge 23 may deteriorate. Moreover, when the cleaning liquid 38 that constitutes the holding liquid 35 reaches the ink cartridge 23, the quality of the white ink 36 in the ink cartridge 23 may deteriorate. In the present embodiment, the main processing (refer to FIG. 6) is performed to inhibit the holding liquid 35 from entering the ink cartridges 23 and 24.

As shown in FIG. 6, when the main processing starts, the CPU 81 determines whether a print command has been obtained via the operation portion 17 shown in FIG. 5 (step S111). When the print command has not been obtained (no at step S111), the CPU 81 moves on to the processing of step S121. When the print command has been obtained (yes at step S111), the CPU 81 refers to the RAM 83 and determines whether the nozzle surface 311 is in the wetted state shown in FIG. 4 based on the state of a wetted flag (step S112). The wetted flag indicates whether the nozzle surface 311 is in the wetted state and is stored in the RAM 83. When the nozzle surface 311 is in the wetted state, the wetted flag is on. When the nozzle surface 311 is not in the wetted state, the wetted flag is off.

When the wetted flag is on and the nozzle surface 311 is in the wetted state (yes at step 112), the CPU 81 performs de-wetting processing (step S113). As will be described in more detail later, in the de-wetting processing (step S113), the wetted state is removed. The CPU 81 moves the processing on to the processing of step S114. When the wetted flag is off and the nozzle surface 311 is not in the wetted state (no at step S112), the CPU 81 moves the processing on to the processing of step S114. The CPU 81 performs uncapping processing in the state where the wetted state is removed (step S114). In the uncapping processing (step S114), the CPU 81 controls the cap motor 48 shown in FIG. 5 to lower the cap support portion 47 shown in FIG. 3. As a result, the cap 41 separates downward from the nozzle surface 311 of the head 31, thereby changing from the capping state shown in FIG. 3 and FIG. 4 to the uncapping state shown in FIG. 2.

The CPU 81 performs print processing in the uncapping state shown in FIG. 2 (step S115). In the print processing (step S115), the CPU 81 controls the main scanning motor 99, the sub-scanning motor 97, and the head drive portion 301 shown in FIG. 5 to perform printing to the print medium with the heads 31 and 32 shown in FIG. 1. When the print processing ends, the CPU 81 performs the capping processing (step S116). In the capping processing (step S116), the CPU 81 controls the cap motor 48 shown in FIG. 5 to raise the cap support portion 47 shown in FIG. 3. The cap 41 contacts the nozzle surface 311 of the head 31, thus forming the holding space 42. As a result, the cap 41 changes from the uncapping state shown in FIG. 2 to the capping state shown in FIG. 3 and FIG. 4. The CPU 81 performs end-of-work processing (step S122) and circulation processing (step S132), to be described later, in the capping state. The CPU 81 then moves the processing on to the processing of step S121.

The CPU 81 determines whether to perform the end-of-work processing (step S121). For example, a final maintenance time set by the user is stored in the flash memory 84. When it is not the end-of-work maintenance time, the CPU 81 determines that the end-of-work processing is not to be performed (no at step S121). In this case, the CPU 81 moves the processing on to the processing of step S131. When it is the end-of-work maintenance time, the CPU 81 determines that the end-of-work processing is to be performed (yes at step S121). In this case, the CPU 81 performs the end-of-work processing (step S122). As will be described in more detail later, in the end-of-work processing (step S122), the nozzle surface 311 is controlled to the wetted state shown in FIG. 4. The CPU 81 then moves the processing on to the processing of step S131.

The CPU 81 determines whether to perform the circulation processing (step S131). For example, a circulation interval time set by the user is stored in the flash memory 84. When the circulation interval time has not passed after the most recent circulation processing, the CPU 81 determines that the circulation processing is not to be performed (no at step S131). In this case, the CPU 81 returns the processing to the processing of step S111. When the circulation interval time has passed after the most recent circulation processing, the CPU 81 determines that the circulation processing is to be performed (yes at step S131). In this case, the CPU 81 performs the circulation processing (step S132). As will be described in detail later, in the circulation processing (step S132), circulation of the white ink 36 via the flow path 50 shown in FIG. 4, and circulation of the white ink 37 via the flow path 60 shown in FIG. 4 are controlled. The CPU 81 then returns the processing to the processing of step S111.

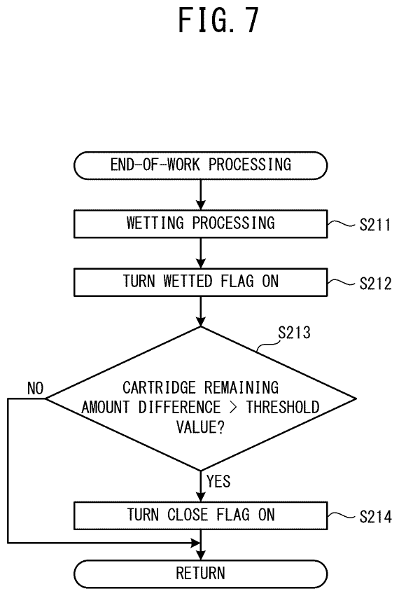

The end-of-work processing will now be described with reference to FIG. 4 and FIG. 7. The end-of-work processing starts when the pair of valves 521 and 531 and the pair of valves 621 and 631 shown in FIG. 4 are in the open state. When the end-of-work processing starts, the CPU 81 performs wetting processing (step S211). In the wetting processing (step S211), the CPU 81 controls the valve 721 shown in FIG. 4 closed and controls the valves 711 and 911 shown in FIG. 4 open. In this state, the CPU 81 drives the pump 912 shown in FIG. 4. As a result, as shown in FIG. 4, the cleaning liquid 38 flows from the cleaning liquid tank 70 through the flow path 71 toward the point P31, and flows to the holding space 42 (refer to arrow A31). The cap 41 is in a state where the cleaning liquid 38 is contained in the holding space 42 as the holding liquid 35.

After the pump 912 continues to be driven for a certain period of time, the holding space 42 fills up with the cleaning liquid 38 as the holding liquid 35. In this case, the holding liquid 35 contacts the nozzle surface 311. The CPU 81 then stops driving the pump 912. When the pump 912 stops being driven, the CPU 81 closes the valves 711 and 911. As a result, the cap 41 holds the holding liquid 35 in the holding space 42 and is in a holding state (wetted state in the present embodiment). In the present embodiment, the time until the holding space 42 is filled with the holding liquid 35 (cleaning liquid 38) is stored in the ROM 82 as the driving time of the pump 912. The CPU 81 turns the wetted flag on in the RAM 83 (step S212).

The likelihood that the holding liquid 35 will enter the ink cartridge with the lower pressure increases as the cartridge pressure difference increases. Therefore, as shown in FIG. 7, the CPU 81 determines whether a cartridge remaining amount difference exceeds a predetermined threshold value (step S213). The threshold value is a value of the cartridge pressure difference that is sufficient to prevent the holding liquid 35 shown in FIG. 4 from substantially entering the ink cartridge with the lower pressure. The threshold value is stored beforehand in the ROM 82. In the processing of step S213, the CPU 81 identifies the remaining amount in the ink cartridge 23 based on a signal from the remaining amount sensor 231 shown in FIG. 5, and identifies the remaining amount in the ink cartridge 24 based on a signal from the remaining amount sensor 241 shown in FIG. 5. The CPU 81 identifies the cartridge remaining amount difference based on the remaining amount in the ink cartridge 23 and the remaining amount in the ink cartridge 24 that were identified. The CPU 81 then compares the identified cartridge remaining amount difference with the threshold value.

When the cartridge remaining amount difference exceeds the threshold value (yes at step S213), the CPU 81 turns on a close flag in the RAM 83 (step S214). The close flag is a flag for advancing the processing from the processing of step S611 to the processing of step S612 in valve closing processing (refer to FIG. 13) that will be described later, and is stored in the RAM 83. When the processing advances from the processing of step S611 to the processing of step S612, the close flag turns on. When the processing repeats the processing of step S611, the close flag is off.

By performing the processing of step S214, the processing advances from the processing of step S611 to the processing of step S612 in the valve closing processing (refer to FIG. 13). As will be described in detail later, in the valve closing processing, by advancing the processing from the processing of step S611 to the processing of step S612, control of the valves 521, 531, 621, and 631 shown in FIG. 4 is performed, such that one pair or both pairs (one pair in the present embodiment) of the pair of valves 521 and 531 and the pair of valves 621 and 631 closes. Therefore, after the processing of step S214, the CPU 81 performs each processing in the main processing with one pair or both pairs of the pair of valves 521 and 531 and the pair of valves 621 and 631 closed until the close flag turns off. As a result, when the cartridge remaining amount difference exceeds the threshold value, the holding liquid 35 is inhibited from entering the ink cartridge with the lower pressure. The CPU 81 then returns the processing to the main processing shown in FIG. 6.

When the cartridge remaining amount difference is equal to or less than the threshold value (no at step S213), the CPU 81 returns the processing to the main processing shown in FIG. 6 without turning on the close flag. In this case, opening and closing of the valves 521, 531, 621, and 631 is not performed in the valve closing processing (refer to FIG. 13), so a meniscus formed on the plurality of nozzles 313 is inhibited from being damaged from the impact by the opening and closing of the valves 521, 531, 621, and 631.

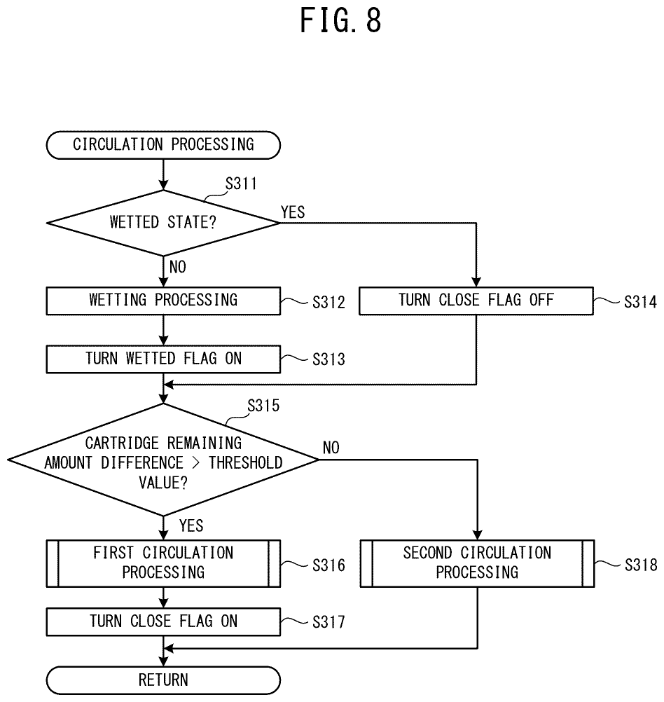

The circulation processing will now be described with reference to FIG. 8. In the present embodiment, in the circulation processing, the CPU 81 controls first circulation processing (step S316) and second circulation processing (step S318), described later, in the wetted state. Therefore, when the circulation processing starts, the CPU 81 references the RAM 83 and determines whether the nozzle surface 311 is in the wetted state based on the state of the wetted flag (step S311). When the wetted flag is on, the nozzle surface 311 is in the wetted state shown in FIG. 4 (yes at step S311). In this case, the CPU 81 turns the close flag off in the RAM 83 (step S314). The CPU 81 then advances the processing on to the processing of step S315.

When the wetted flag is off, the nozzle surface 311 is not in the wetted state (no at step S311). In this case, the CPU 81 performs wetting processing (step S312). The wetting processing of step S312 is the same as the wetting processing of step S211 shown in FIG. 7. The wetting processing of step S312 brings the nozzle surface 311 into the wetted state shown in FIG. 4. The CPU 81 turns on the wetted flag in the RAM 83 (step S313). The CPU 81 then advances the processing on to the processing of step S315.

The CPU 81 determines whether the cartridge remaining amount difference exceeds the threshold value, in a similar manner to the processing of step S213 shown in FIG. 7 (step S315). When the cartridge remaining amount difference exceeds the threshold value (yes at step S315), the CPU 81 performs the first circulation processing (step S316). After the first circulation processing (step S316) ends, the CPU 81 turns on the close flag in the RAM 83 (step S317). The CPU 81 then returns the processing to the main processing shown in FIG. 6). When the cartridge remaining amount difference is equal to or less than the threshold value (no at step S315), the CPU 81 performs the second circulation processing (step S318). After the second circulation processing (step S318) ends, the CPU 81 returns the processing to the main processing shown in FIG. 6.

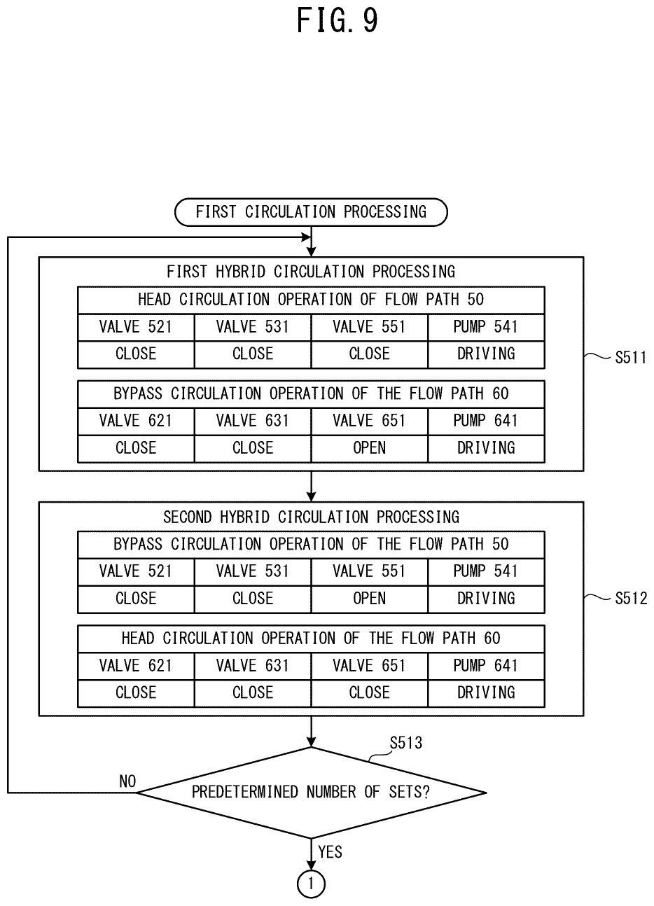

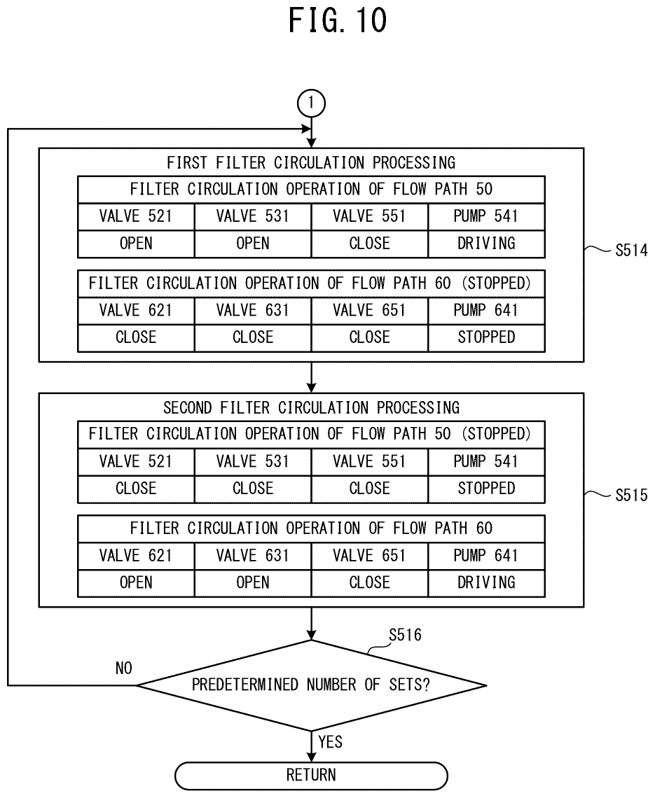

The first circulation processing will now be described with reference to FIG. 4, FIG. 9, and FIG. 10. As shown in FIG. 9, when the first circulation processing starts, the CPU 81 performs first hybrid circulation processing (step S511). In the first hybrid circulation processing (step S511), the CPU 81 controls a head circulation operation of the flow path 50 and a bypass circulation operation of the flow path 60.

As shown in FIG. 4 and FIG. 9, in the head circulation operation of the flow path 50, the CPU 81 closes the pair of valves 521 and 531 and closes the valve 551. In this state, the CPU 81 drives the pump 541. In this case, the white ink 36 circulates in the flow path 50 as shown by arrow A11. In other words, the white ink 36 flows from the pump 541 toward the point P12 in the flow path 54. The white ink 36 flows through the flow path 52 from the point P12 toward the point P14, and flows to the nozzle group W1. The white ink 36 flows from the nozzle groups W1 to the nozzle group W2 via the communication path 314. The white ink 36 flows through the flow path 53 from the nozzle group W2 toward the point P15, and flows to the point P13. The white ink 36 flows through the flow path 54 from the point P13 toward the point P12, and circulates. As a result, the white ink 36 is inhibited from increasing in viscosity near the nozzle groups W1 and W2 in the flow path 50. When a predetermined pump driving time during the head circulation operation of the flow path 50 has passed, the CPU 81 stops the pump 541. As a result, the head circulation operation of the flow path 50 ends.

In the bypass circulation operation of the flow path 60, the CPU 81 closes the valves 621 and 631 and keeps the valve 651 open. In this state, the CPU 81 drives the pump 641. In this case, the white ink 37 circulates in the flow path 60 as shown by the arrow A22. In other words, the white ink 37 flows from the pump 641 toward the point P22 in the flow path 64. The white ink 37 flows through the flow path 62 from the point P22 toward the point P24. The white ink 37 flows from the point P24 toward the point P25 through the flow path 65. The white ink 37 flows through the flow path 63 from the point P25 toward the point P23. The white ink 37 flows through the flow path 64 from the point P23 toward the point P22, and circulates. As a result, negative pressure in the nozzle groups W3 and W4 is inhibited. When a predetermined pump driving time during the bypass circulation operation of the flow path 60 has passed, the CPU 81 stops the pump 641. As a result, the bypass circulation operation of the flow path 60 ends.

As shown in FIG. 9, in the present embodiment, in the first hybrid circulation processing (step S511), the CPU 81 proceeds with the head circulation operation of the flow path 50 and the bypass circulation operation of the flow path 60 in parallel with each other. The CPU 81 may alternatively proceed with the head circulation operation of the flow path 50 and the bypass circulation operation of the flow path 60 offset from one another. After the first hybrid circulation processing (step S511) ends, the CPU 81 performs second hybrid circulation processing (step S512). In the second hybrid circulation processing (step S512), the CPU 81 controls the bypass circulation operation of the flow path 50 and the head circulation operation of the flow path 60.

As shown in FIG. 4 and FIG. 9, in the bypass circulation operation of the flow path 50, the CPU 81 opens the valve 551 and keeps the pair of valves 521 and 531 closed. In this state, the CPU 81 drives the pump 541. In this case, the white ink 36 circulates in the flow path 50 as shown by arrow A12. In other words, the white ink 36 flows from the pump 541 toward the point P12 in the flow path 54. The white ink 36 flows through the flow path 52 from the point P12 toward the point P14. The white ink 36 flows from the point P14 toward the point P15 through the flow path 55. The white ink 36 flows through the flow path 53 from the point P15 toward the point P13. The white ink 36 flows through the flow path 54 from the point P13 toward the point P12, and circulates. As a result, negative pressure in the nozzle groups W1 and W2 is inhibited. When a predetermined pump driving time during the bypass circulation operation of the flow path 50 has passed, the CPU 81 stops the pump 541. As a result, the bypass circulation operation of the flow path 50 ends.

In the head circulation operation of the flow path 60, the CPU 81 keeps the pair of valves 621 and 631 closed and closes the valve 651. In this state, the CPU 81 drives the pump 641. In this case, the white ink 37 circulates in the flow path 60 as shown by the arrow A21. In other words, the white ink 37 flows from the pump 641 toward the point P22 in the flow path 64. The white ink 37 flows through the flow path 62 from the point P22 toward the point P24, and flows to the nozzle group W3. The white ink 37 flows from the nozzle group W3 to the nozzle group W4 via the communication path 315. The white ink 37 flows through the flow path 63 from the nozzle group W4 toward the point P25, and flows to the point P23. The white ink 37 flows through the flow path 64 from the point P23 toward the point P22, and circulates. As a result, the white ink 37 is inhibited from increasing in viscosity near the nozzle groups W3 and W4 in the flow path 60. When a predetermined pump driving time during the head circulation operation of the flow path 60 has passed, the CPU 81 stops the pump 641. As a result, the head circulation operation of the flow path 60 ends.

As shown in FIG. 9, in the present embodiment, in the second hybrid circulation processing (step S512), the CPU 81 proceeds with the bypass circulation operation of the flow path 50 and the head circulation operation of the flow path 60 in parallel with each other. The CPU 81 may alternatively proceed with the bypass circulation operation of the flow path 50 and the head circulation operation of the flow path 60 offset from one another. After the second hybrid circulation processing (step S512) ends, the CPU 81 counts the first hybrid circulation processing, together with the second hybrid circulation processing following the first hybrid circulation processing, as one set of hybrid circulation operations, and determines whether the number of sets of executed hybrid circulation operations is a predetermined number of sets (for example, three sets) (step S513). When the number of sets of executed hybrid circulation operations is less than the predetermined number of sets (no at step S513), the CPU 81 returns the processing to the processing of step S511. As a result, the hybrid circulation operation is repeated. When the number of sets of executed hybrid circulation operations has reached the predetermined number of sets (yes at step S513), the CPU 81 advances the processing on to the processing of step S514 shown in FIG. 10.

As shown in FIG. 10, the CPU 81 performs first filter circulation processing (step S514). In the first filter circulation processing (step S514), the CPU 81 executes a filter circulation operation of the flow path 50. As shown in FIG. 4 and FIG. 10, in the filter circulation operation of the flow path 50, the CPU 81 opens the pair of valves 521 and 531 and closes the valve 551. In this state, the CPU 81 drives the pump 541. In this case, the white ink 36 circulates in the flow path 50 as shown by the arrow A13. In other words, the white ink 36 flows from the pump 541 toward the point P12 in the flow path 54. The white ink 36 flows through the flow path 52 from the point P12 toward the point P11. The white ink 36 flows through the flow path 53 from the point P11 toward the point P13. The white ink 36 flows through the flow path 54 from the point P13 toward the point P12, and circulates. As a result, deposits on the filters 522, 532, and 542 are removed. When a predetermined pump driving time during the filter circulation operation of the flow path 50 has passed, the CPU 81 stops the pump 541. As a result, the filter circulation operation of the flow path 50 ends.

In the first filter circulation processing (step S514), the CPU 81 keeps the filter circulation operation of the flow path 60 stopped during execution of the filter circulation operation of the flow path 50. In this case, the CPU 81 controls the pair of valves 621 and 631, and the valve 651, closed. The CPU 81 keeps the pump 641 stopped.

As shown in FIG. 10, after the first filter circulation processing ends, the CPU 81 performs second filter circulation processing (step S515). In the second filter circulation processing (step S515), the CPU 81 executes the filter circulation operation of the flow path 60. As shown in FIG. 4 and FIG. 10, in the filter circulation operation of the flow path 60, the CPU 81 opens the pair of valves 621 and 631, and closes the valve 651. In this state, the CPU 81 drives the pump 641. In this case, the white ink 37 circulates in the flow path 60 as shown by the arrow A23. In other words, the white ink 37 flows from the pump 641 toward the point P22 in the flow path 64. The white ink 37 flows through the flow path 62 from the point P22 toward the P21. The white ink 37 flows through the flow path 63 from the point P21 toward the point P23. The white ink 37 flows through the flow path 64 from the point P23 toward the point P22, and circulates. As a result, deposits on the filters 622, 632, and 642 are removed. When a predetermined pump driving time during the filter circulation operation of the flow path 60 has passed, the CPU 81 stops the pump 641. As a result, the filter circulation operation of the flow path 60 ends.

In the second filter circulation processing (step S515), the CPU 81 keeps the filter circulation operation of the flow path 50 stopped during execution of the filter circulation operation of the flow path 60. In this case, the CPU 81 controls the pair of valves 521 and 531, and the valve 551, closed. The CPU 81 keeps the pump 541 stopped.

As shown in FIG. 10, after the second filter circulation processing (step S515) ends, the CPU 81 counts the first filter circulation processing, together with the second filter circulation processing following the first filter circulation processing, as one set of filter circulation operations, and determines whether the number of sets of executed filter circulation operations is a predetermined number of sets (for example, three sets) (step S516). When the number of sets of executed filter circulation operations is less than the predetermined number of sets (no at step S516), the CPU 81 returns the processing to the processing of step S514. As a result, the filter circulation operation is repeated. When the number of sets of executed filter circulation operations has reached the predetermined number of sets (yes at step S516), the CPU 81 returns the processing to the main processing shown in FIG. 6.

Hereinafter, a state in which the white ink 36 circulates through each of the flow paths 52 and 53 shown in FIG. 4 is referred to as the “circulating state of the flow path 50,” and a state in which the white ink 37 circulates through each of the flow paths 62 and 63 shown in FIG. 4 is referred to as the “circulating state of the flow path 60.” In the present embodiment, the circulating state of the flow path 50 is a state in which at least one of the head circulation operation of the flow path 50, the bypass circulation operation of the flow path 50, or the filter circulation operation of the flow path 50 is being performed. In the present embodiment, the circulating state of the flow path 60 is a state in which at least one of the head circulation operation of the flow path 60, the bypass circulation operation of the flow path 60, or the filter circulation operation of the flow path 60 is being performed.

As described above, in the first filter circulation processing (step S514), the CPU 81 controls the pair of valves 621 and 631 closed during the circulating state of the flow path 50. In the second filter circulation processing (step S515), the CPU 81 controls the pair of valves 521 and 531 closed during the circulating state of the flow path 60.

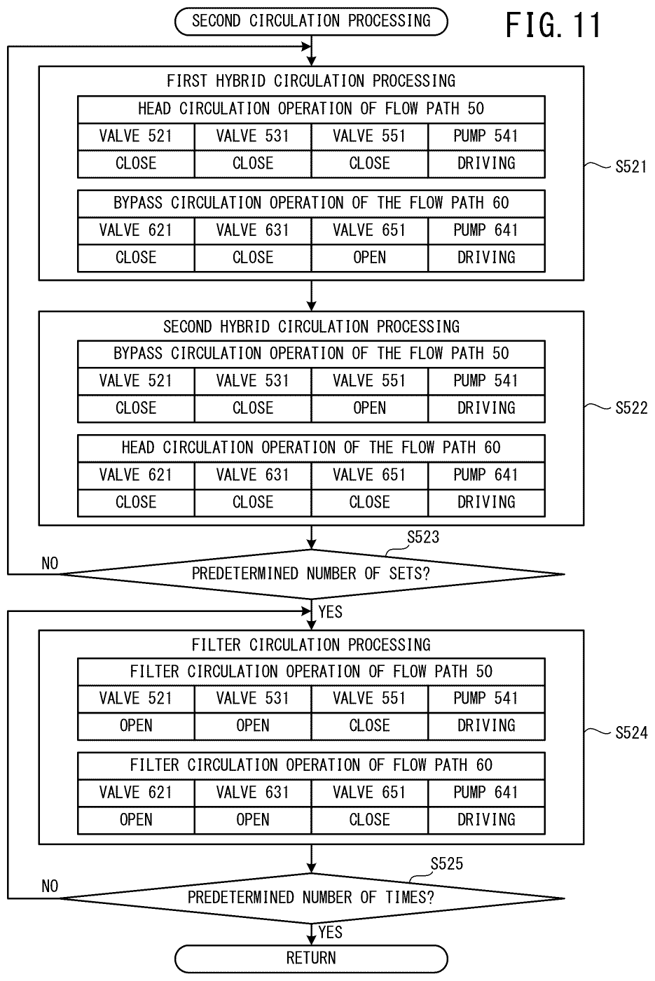

The second circulation processing will now be described with reference to FIG. 11. The CPU 81 performs the first hybrid circulation processing (step S521). The first hybrid circulation processing of step S521 is the same as the first hybrid circulation processing of step S511 shown in FIG. 9. Therefore, the white ink 36 circulates in the flow path 50 as shown by the arrow A11, and the white ink 37 circulates in the flow path 60 as shown by the arrow A22 (refer to FIG. 4).

After the first hybrid circulation processing (step S521) ends, the CPU 81 performs the second hybrid circulation processing (step S522). The second hybrid circulation processing of step S522 is the same as the second hybrid circulation processing of step S512 shown in FIG. 9. Therefore, the white ink 36 circulates in the flow path 50 as shown by the arrow A12, and the white ink 37 circulates in the flow path 60 as shown by the arrow A21 (refer to FIG. 4).

After the second hybrid circulation processing (step S522) ends, the CPU 81 determines whether the number of sets of executed hybrid circulation operations has reached a predetermined number of sets, just like the processing of step S523 shown in FIG. 9 (step S523). When the number of sets of executed hybrid circulation operations is less than the predetermined number of sets (no at step S523), the CPU 81 returns the processing to the processing of step S521. As a result, the hybrid circulation operation is repeated. When the number of sets of executed hybrid circulation operations has reached the predetermined number of sets (yes at step S523), the CPU 81 advances the processing on to the processing of step S524.

The CPU 81 performs filter circulation processing (step S524). In the filter circulation processing (step S524), the CPU 81 proceeds with the filter circulation operation of the flow path 50 and the filter circulation operation of the flow path 60 in parallel with each other. The filter circulation operation of the flow path 50 in the filter circulation processing of step S524 is the same as the filter circulation operation of the flow path 50 in the first filter circulation processing of step S514 shown in FIG. 10. Therefore, the white ink 36 circulates in the flow path 50 as shown by the arrow A13 (refer to FIG. 4). The filter circulation operation of the flow path 60 in the filter circulation processing of step S524 is the same as the filter circulation operation in the second filter circulation processing of step S515 shown in FIG. 10. Therefore, the white ink 37 circulates in the flow path 60 as shown by the arrow A23 (refer to FIG. 4).

After the filter circulation processing (step S524) ends, the CPU 81 determines whether the number of times the filter circulation processing has been executed has reached a predetermined number of times (for example, three times) (step S525). When the number of times the filter circulation processing has been executed is less than the predetermined number of times (no at step S525), the CPU 81 returns the processing to the processing of step S524. As a result, the filter circulation processing is repeated. When the number of times the filter circulation processing has been executed has reached the predetermined number of times (yes at step S525), the CPU 81 returns the processing to the main processing shown in FIG. 6.

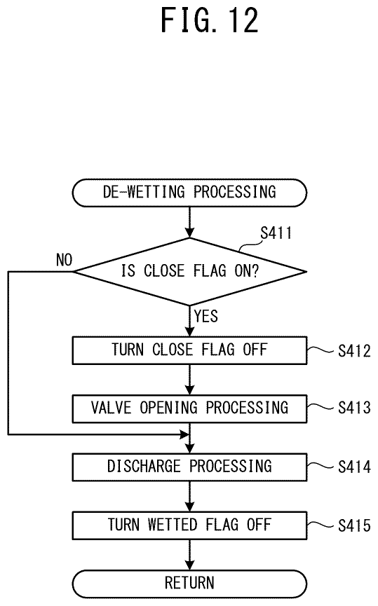

The de-wetting processing will now be described with reference to FIG. 4 and FIG. 12. The CPU 81 references the RAM 83 and determines whether the close flag is on (step S411). When the close flag is off (no at step S411), the CPU 81 advances the processing on to the processing of step S414. When the close flag is on (yes at step S411), the CPU 81 turns the close flag off in the RAM 83 (step S412). As a result, control of the valves 521, 531, 621, and 631 by the valve closing processing (refer to FIG. 13) ends. The CPU 81 then performs valve opening processing (step S413). In the valve opening processing (step S413), the CPU 81 opens the pair of valves that are closed, from among the pair of valves 521 and 531 and the pair of valves 621 and 631 shown in FIG. 4. As a result, both pairs of valves, i.e., both the pair of valves 521 and 531 and the pair of valves 621 and 631, are open.

The CPU 81 performs discharge processing (step S414). In the discharge processing (step S414), the CPU 81 opens the valves 711, 721, and 911, as shown in FIG. 4. In this state, the CPU 81 drives the pump 912. As a result, the holding liquid 35 flows from the holding space 42 to the waste tank 90 through the flow path 91 (refer to arrow A32). Moreover, air flows from the atmosphere 73 toward the point P31 through the flow path 72, and then to the holding space 42 through the flow path 71, without the cleaning liquid 38 being supplied from the cleaning liquid tank 70 to the holding space 42 (refer to arrow A33). Therefore, after the pump 912 continues to be driven for a certain period of time, practically all of the holding liquid 35 is discharged to the waste tank 90 as waste liquid 39, and the holding space 42 is filled with air. As a result, the wetted state is removed.

In the present embodiment, the time until practically all of the holding liquid 35 is discharged to the waste tank 90 as the waste liquid 39 and the holding space 42 becomes filled with air is stored in the ROM 82 as the driving time of the pump 912. As shown in FIG. 12, when the driving of the pump 912 is stopped, the CPU 81 turns off the wetted flag in the RAM 83 (step S415). The CPU 81 then returns the processing to the main processing shown in FIG. 6.

The valve closing processing will now be described with reference to FIG. 4 and FIG. 13. When the power supply to the printer 1 is turned on, the CPU 81 reads the closing processing program from the ROM 82 and operates the closing processing program to execute the valve closing processing. In this case, the CPU 81 proceeds with the valve closing processing in parallel with the main processing. In the valve closing processing, opening and closing control of the pair of valves 521 and 531 and the pair of valves 621 and 631 is performed.

When the valve closing processing starts, the CPU 81 references the RAM 83 and determines whether the close flag is on (step S611). When the close flag is kept off (no at step S611), the CPU 81 repeats the processing of step S611 until the close flag turns on. The close flag turns on by the processing of step S214 shown in FIG. 7 or step S317 shown in FIG. 8 (yes at step S611). In other words, when the cap 41 is in the holding state (wetted state) shown in FIG. 4, the close flag turns on. In this case, the CPU 81 closes the pair of valves 521 and 531 shown in FIG. 4 (step S612). In the present embodiment, in step S612, the CPU 81 closes the pair of valves 521 and 531 at different timings. For example, the CPU 81 closes the valve 531 when a predetermined standby time has passed after closing the valve 521. As a result, the amount of electricity that it takes to close both of the valves 521 and 531 can be reduced compared to when the valves 521 and 531 are closed simultaneously. The standby time is shorter than the time from when a first switching timing is reached until the time when a second switching timing is reached, which will be described later. The duration of the standby time is not particularly limited, but is, for example, approximately several seconds.

Note that the close flag turns on after the wetting processing (step S211) shown in FIG. 7 is performed, as described above. Therefore, the CPU 81 closes the pair of valves 521 and 531 shown in FIG. 4 by the processing of step S612 after the cap 41 is in the holding state (the wetted state in the present embodiment).

A state in which neither the flow path 50 nor the flow path 60 are in a circulating state is referred to as a “non-circulating state,” and a state in which one or both of the flow path 50 and the flow path 60 are in a circulation state is referred to as a “circulating state.” The close flag turns off by the processing of step S314 before the first circulation processing (step S316) and the second circulation processing (step S318) shown in FIG. 8 are performed, and will not turn on in the circulating state. Therefore, the CPU 81 closes the pair of valves 521 and 531 by the processing of step S612 in the non-circulating state.

The CPU 81 determines whether the close valve is off referring to the RAM 83 (step S613). The close flag turns off by the processing of step S314 shown in FIG. 8 or the processing of step S412 shown in FIG. 12 in the main processing (yes at step S613). In this case, the CPU 81 returns the processing to the processing of step S611. In this case, the CPU 81 repeats the processing of step S611 until the close flag turns on again. When the close flag is kept on (no at step S613), the CPU 81 determines whether both the ink cartridges 23 and 24 are in the connected state based on the signal from the connection sensors 232 and 242 shown in FIG. 5 (step S614).

When both the ink cartridges 23 and 24 are in the connected state (yes at step S614), the CPU 81 determines whether the switching timing is reached (step S615). The switching timing may be a timing at which a predetermined switching period has passed after the processing of step S612 or last switching processing (step S616) was performed, for example. The switching timing may be a predetermined switching time, for example. The switching period or the switching time may be stored in the ROM 82, or may be set by the user and stored in the flash memory 84.

When the switching timing has not yet been reached (no at step S615), the CPU 81 returns the processing to the processing of step S613. When the switching timing has been reached (yes at step S615), the CPU 81 performs switching processing (step S616). Hereinafter, a state in which the pair of valves 521 and 531 are closed and the pair of valves 621 and 631 are open is referred to as a “first valve state,” and a state in which the pair of valves 521 and 531 are open and the pair of valves 621 and 631 are closed is referred to as a “second valve state.” In the switching processing (step S616), the CPU 81 switches between the first valve state and the second valves state. For example, the CPU 81 closes the pair of valves, from among the pair of valves 521 and 531 and the pair of valves 621 and 631, that are open, and opens the pair of valves, from among the pair of valves 521 and 531 and the pair of valves 621 and 631, that are closed.

In the present embodiment, in the switching processing (step S616), the CPU 81 closes the each of pair of open valves at different timings, similar to the processing of step S612. In other words, the CPU 81 closes one of the pair of open valves when the predetermined standby time has passed after closing the other of the pair of open valves. The CPU 81 then returns the processing to the processing of step S613.

For example, if the opening and closing of the valve 521 is switched, or the opening and closing of the valve 531 is switched, with the ink cartridge 23 removed from the flow path 51, air may enter the flow path 50 from the connection port 511, or the white ink 36 may leak out from the flow path 50 through the connection port 511, due to a change in pressure caused by opening and closing the valves 521 and 531. Similarly, if the opening and closing of the valve 621 is switched, or the opening and closing of the valve 631 is switched, while the ink cartridge 24 is removed from the flow path 61, air may enter the flow path 60 from the connection port 611, or the white ink 37 may leak out from the flow path 60 through the connection port 611.

When one or both of the ink cartridges 23 and 24 are disconnected (no at step S614), the CPU 81 returns the processing to the processing of step S613. As a result, the switching processing (step S616) is prohibited from being performed while the ink cartridge 23 is removed from the flow path 51, and the switching processing (step S616) is prohibited from being performed while the ink cartridge 24 is removed from the flow path 61. In this way, after performing the processing of step S214 shown in FIG. 7 or the processing S317 shown in FIG. 8, the CPU 81 performs the processing of step S412 shown in FIG. 12, or repeats the switching processing (step S616) each time the switching timing is reached (yes at step S615) until one or both of the ink cartridges 23 and 24 is/are disconnected.

When one or both of the ink cartridges 23 and 24 are reconnected (yes at step S614) after one or both of the ink cartridges 23 and 24 were disconnected, the CPU 81 repeats the switching processing (step S616) each time the switching timing is reached (yes at step S615). In this case, the CPU 81 may continue timing the switching period, or pause timing the switching period, during the period during which one or both of the ink cartridges 23 and 24 are disconnected. For example, when timing the switching period is continued during the period during which one or both of the ink cartridges 23 and 24 are disconnected, the CPU 81 may determine that the switching timing has been reached when a predetermined switching period or longer has passed after the processing of step S612 or the last switching processing (step S616) has been performed, at the point of the processing of step S615. Alternatively, when a predetermined switching time has passed at the point of the processing of step S615, the CPU 81 may determine that the switching timing has been reached, or may determine that the switching timing has not been reached until the next switching time after the predetermined switching time has passed.

An example will be described of the operations and effects according to the above-described embodiment. In the above-described embodiment, in the holding state or the non-circulating state, the CPU 81 controls one pair of valves, from among the pair of valves 521 and 531 and the pair of valves 621 and 631, closed (to the first valves state or the second valves state). For example, at the point the processing of step S214 and step S317 is performed and the close flag turns on, the cap 41 is in the holding state (wetted state), and the flow paths 50 and 60 are in the noncirculating state. When the close flag turns on (yes at step S611), the CPU 81 controls the pair of valves 521 and 531 closed by the processing of step S612. Consequently, closed pair of valves 521 and 531 close off the flow path 50 between the ink cartridge 23 and each of the nozzle groups W1 and W2. Therefore, even if the nozzle groups W1 and W2 and the nozzle groups W3 and W4 are connected such that liquid can move between them, the ink cartridge 23 and the ink cartridge 24 are unlikely to be connected such that liquid can move between them via the holding liquid 35. Therefore, even if there were a cartridge pressure difference, this cartridge pressure difference would not likely affect the pressure difference between the nozzle groups W1 and W2 and the nozzle groups W3 and W4. As a result, the printer 1 contributes to reducing the likelihood that the holding liquid 35 will enter the ink cartridges 23 and 24.

For example, when there is no switch from the first valve state to the second valve state, the pair of valves 521 and 531 will continue to be in a heat-generating state for a long time. In this case, the valves 521 and 531 will continue to be in the heat-generating state for a long time. Therefore, the valves 521 and 531 may degrade, and the heat generated by the valves 521 and 531 may adversely affect the white ink 36. In the above-described embodiment, when the holding state and the noncirculating state are established, the CPU 81 switches between the first valve state and the second valve state (step S616). As a result, the heat-generating state of one of the pair of valves 521 and 531 and the pair of valves 621 and 631 is suppressed for longer than it is when the first valve state or the second valves state is not switched. Thus, the printer 1 contributes to suppressing the effect of heat generation by the pair of valves 521 and 531 or the pair of valves 621 and 631 on the white ink 36 and 37. The printer 1 contributes to reducing deterioration in the durability of the pair of valves 521 and 531 or the pair of valves 621 and 631.

When it is detected that at least one of the ink cartridge 23 and the flow path 50, or the ink cartridge 24 and the flow path 60, have been disconnected (no at step S614) when the holding state, the noncirculating state, and the first valve state are established, the CPU 81 skips the switching processing (step S616), and maintains the first valve state. When it is detected that at least one of the ink cartridge 23 and the flow path 50, and the ink cartridge 24 and the flow path 60, have been disconnected when the holding state, the noncirculating state, and the second valve state are established (no at step S614), the CPU 81 skips the switching processing (step S616) and maintains the second valve state. As a result, in the printer 1, a switch is not made from one of the first valve state or the second valve state to the other while one or both of the ink cartridge 23 and ink cartridge 24 are in the disconnected state. Thus, the printer 1 contributes to inhibiting the white ink 36 and 37 from leaking from the flow path 50 and 60, or inhibiting air from entering the flow paths 50 and 60.

Each of the pair of valves 521 and 531 and the pair of valves 621 and 631 open when de-energized and close when energized. When the cartridge remaining amount difference exceeds the threshold value when the holding state and the noncirculating state are established (yes at step S213 or yes at step S315), the CPU 81 turns the close flag on and controls one of the pair of valves 521 and 531 or the pair of valves 621 and 631 closed (to the first valve state or the second valve state) (step S612). When the cartridge remaining amount difference is less than the threshold value when the holding state and the noncirculating state are established (no at step S213 and no at step S315), the close flag is kept off, so the CPU 81 controls both the pair of valves 521 and 531 and the pair of valves 621 and 631 open. Accordingly, when there is a relatively high likelihood that the holding liquid 35 will enter the ink cartridges 23 and 24, one of the pair of valves 521 and 531 or the pair of valves 621 and 631 is energized. Thus, the printer 1 contributes to reducing the likelihood of the holding liquid 35 entering the ink cartridges 23 and 24. On the other hand, when there is a relatively low likelihood that the holding liquid 35 will enter the ink cartridges 23 and 24, the pair of valves 521 and 531 and the pair of valves 621 and 631 are not energized. As a result, the printer 1 contributes to energy saving. In other words, the printer 1 contributes to reducing the likelihood that the holding liquid 35 will enter the ink cartridges 23 and 24, while also contributing to energy saving.

If one or both of the pair of valves 521 and 531 or the pair of valves 621 and 631 is closed before control to the holding state is performed, the meniscus formed on each of the nozzle groups W1 and W2 and the nozzle groups W3 and W4 will be damaged, and there is a possibility that air will enter the flow path 50 from the nozzle groups W1 and W2, or that air will enter the flow path 60 from the nozzle groups W3 and W4. In this case, it is necessary to perform purging to discharge the air from the flow paths 50 and 60. In the above-described embodiment, at the point the processing of step S214 and step S317 are performed and the close flag turns on, the cap 41 is in the holding state and the flow paths 50 and 60 are in the noncirculating state. When the noncirculating state is established after the cap 41 is placed in the holding state, the CPU 81 turns the close flag on and closes one of the pair of valves 521 and 531 or the pair of valves 621 and 631 (step S612). Thus, the printer 1 contributes to inhibiting the meniscus formed on each of the nozzle groups W1 and W2 and the nozzle groups W3 and W4 from being damaged, and air from entering the flow paths 50 and 60.

When the holding state is established and the circulating state of the flow path 50 is established, the CPU 81 controls both of the pair of valves 621 and 631 closed (step S514). When the holding state is established and the circulating state of the flow path 60 is established, the CPU 81 controls both of the valves 521 and 531 closed (step S515). Accordingly, the printer 1 contributes to reducing the likelihood that the holding liquid 35 will enter the ink cartridges 23 and 24 when the circulating state of the flow path 50 and the circulating state of the flow path 60 are established, as well as when the noncirculating state is established.

In the above-described embodiment, the nozzle surface 311 is an example of the “nozzle surface” of the present disclosure. The nozzle groups W1 and W2 are an example of the “first nozzle” of the present disclosure. The nozzle groups W3 and W4 are an example of the “second nozzle” of the present disclosure. The white ink 36 is an example of the “first discharge liquid” of the present disclosure. The white ink 37 is an example of the “second discharge liquid” of the present disclosure. The ink cartridge 23 is an example of the “first container” of the present disclosure. The ink cartridge 24 is an example of the “second container” of the present disclosure. The flow path 52 is an example of the “first flow path” of the present disclosure. The valve 521 is an example of the “first valve” of the present disclosure. The flow path 62 is an example of the “second flow path” of the present disclosure. The valve 621 is an example of the “second valve” of the present disclosure. The holding space 42 is an example of the “holding space” of the present disclosure. The cleaning liquid 38 is an example of the “cleaning liquid” of the present disclosure. The holding liquid 35 is an example of the “holding liquid” of the present disclosure. The cap 41 is an example of the “cap” of the present disclosure. The CPU 81 is an example of the “processor” and “computer” of the present disclosure.

The remaining amount sensor 231 is an example of the “first sensor” of the present disclosure. The remaining amount sensor 241 is an example of the “second sensor” of the present disclosure. The flow path 53 is an example of the “third flow path” of the present disclosure. The valve 531 is an example of the “third valve” of the present disclosure. The flow path 63 is an example of the “fourth flow path” of the present disclosure. The valve 631 is an example of the “fourth valve” of the present disclosure. The pump 541 is an example of the “first pump” of the present disclosure. The pump 641 is an example of the “second pump” of the present disclosure. The circulating state of the flow path 50 is an example of the “first circulating state” of the present disclosure. The circulating state of the flow path 60 is an example of the “second circulating state” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below. Various modified examples, which will be described below, can be combined with one another as long as no contradictions arise. At least one of the pair of valves 521 and 531 or the pair of valves 621 and 631 may be provided with a self-holding mechanism that closes the valves when energized and holds the valves closed when de-energized while the valves are in the closed state. The self-holding mechanism may employ, for example, a permanent magnet. For example, when the pair of valves 521 and 531 is provided with the self-holding mechanism, the CPU 81 may change the valve closing processing as described below. In the processing of step S612, the CPU 81 closes the pair of valves 521 and 531, and then while the pair of valves 521 and 531 are closed, de-energizes the pair of valves 521 and 531. In other words, the CPU 81 does not have to keep energizing the pair of valves 521 and 531 after closing them by energizing them. In this case, the CPU 81 may omit the processing of step S615 and step S616.

With the above-described modified example, when the pair of valves 521 and 531 are de-energized while they are closed, the self-holding mechanism holds the pair of valves 521 and 531 closed. Accordingly, the printer 1 contributes to reducing the likelihood that the holding liquid 35 will enter the ink cartridges 23 and 24, while also contributing to energy saving.

In the above-described embodiment, the printer 1 may also be configured in such a way that some or all of the head circulation operation, the bypass circulation operation, and the filter circulation operation cannot be executed. The CPU 81 may, in the capping state, discharge at least one of the white ink 36 or 37 instead of the cleaning liquid 38, and fill the holding space 42 with at least one of the white ink 36 or 37 as the holding liquid 35. The wetted flag may indicate whether the cap 41 is in the holding state. In other words, when the wetted flag is on, the nozzle surface 311 does not necessarily have to be in the wetted state as long as the cap 41 is in the holding state.

In the above-described embodiment, the CPU 81 closes one pair, from among the pair of valves 521 and 531 and the pair of valves 621 and 631, in the processing of step S612. Alternatively, the CPU 81 may close both the pair of valves 521 and 531 and the pair of valves 621 and 631 in the processing of step S612. In this case, the CPU 81 may omit the processing of step S615 and step S616.

In the above-described embodiment, the nozzle group W1 is formed by a plurality of nozzle rows. Alternatively, the nozzle group W1 may be formed by one nozzle row, or may be formed by one of the nozzles 313. The nozzle groups W2, W3, and W4 may also be changed in the same way as the nozzle group W1. The printer 1 may omit one of the nozzle groups W1 or W2. The printer 1 may also omit one of the nozzle groups W3 or W4. For example, when the printer 1 omits the nozzle groups W2 and W4, the flow paths 53, 54, and 55 in the flow path 50 may be omitted, and the flow paths 63, 64, and 65 in the flow path 60 may be omitted. Furthermore, the flow paths 50 and 60 may be changed in various ways. For example, in the flow path 50, only the flow path 54 may be omitted, or only the flow path 55 may be omitted. The flow path 50 may connect one or more nozzle groups, in addition to the nozzle groups W1 and W2, to the ink cartridge 23. The flow paths 52 and 53 may be directly connected to the ink cartridge 23 without using the flow path 51. The flow path 60 may also be changed in the same way as the flow path 50.

In the above-described embodiment, in the switching processing (step S616), the CPU 81 may switch between the first valve state and the second valve state via a state in which both the pair of valves 521 and 531 and the pair of valves 621 and 631 are closed. The CPU 81 may omit the switching processing (step S616). In other words, the CPU 81 may keep the pair of valves 521 and 531 closed until the close flag turns off after the pair of valves 521 and 531 are closed by the processing of step S612.

In the above-described embodiment, the printer 1 may be provided with a first ink tank instead of the ink cartridge 23. The printer 1 may be provided with a second ink tank instead of the ink cartridge 24. The printer 1 may be provided with a first sub-pouch instead of the ink cartridge 23. The printer 1 may be provided with a second sub-pouch instead of the ink cartridge 24. The first sub-pouch and the second sub-pouch are each a bag-like container and are flexible. In this case, the first sub-pouch and the second sub-pouch may be connected to an ink cartridge for supplying ink to the first sub-pouch and the second sub-pouch. The first sub-pouch and the second sub-pouch may both be connected to the same ink cartridge, or they may be connected to different ink cartridges. The valves 521, 531, 621, and 631 may be ball valves or the like.

In the valve closing processing, when one or both of the ink cartridges 23 and 24 are disconnected (no at step S614), the CPU 81 may turn the close flag off and return the processing to the processing of step S611. The CPU 81 may omit the processing of step S614. That is, the CPU 81 may perform the switching processing (step S616) regardless of whether one or both of the ink cartridges 23 and 24 are connected. In the printer 1, the connection sensors 232 and 242 may be omitted. In this case, the user may input, via the operation portion 17, a command indicating that one or both of the ink cartridges 23 and 24 are connected. The CPU 81 may detect that one or both of the ink cartridges 23 and 24 are connected by obtaining the input command.

In the printer 1, the remaining amount sensors 231 and 241 may be omitted. In this case, the CPU 81 may omit the processing of one or both of step S213 and step S315. In other words, the CPU 81 may turn the close flag on by the processing of step S214 regardless of whether the cartridge remaining amount difference exceeds the threshold value. The CPU 81 may execute the first circulation processing (step S316) regardless of whether the cartridge remaining amount difference exceeds the threshold value, and may execute the second circulation processing (step S318) regardless of whether the cartridge remaining amount difference exceeds the threshold value.

In the above-described embodiment, after the wetting processing (step S211 and step S312) are performed, the wetting flag is turned on by the processing of step S214 or step S313, and the pair of pair of valves 521 and 531 are closed. Alternatively, the CPU 81 may close one or both pairs of the pair of valves 521 and 531 and the pair of valves 621 and 631 before performing the wetting processing (step S211 and step S312). The CPU 81 may perform the wetting processing (step S211 and step S312) while one or both pairs of the pair of valves 521 and 531 and the pair of valves 621 and 631 are closed.

The ink cartridge 23 may store a liquid other than the white ink 36. The liquid other than the white ink 36 may be, for example, color ink, special color ink, a pre-treatment agent, a decolorizing agent, or a post-treatment agent. Similarly, the ink cartridge 24 may store a liquid other than the white ink 37. The liquid stored in the ink cartridge 24 may be different from the liquid stored in the ink cartridge 23. The CPU 81 may close the pair of valves 521 and 531 simultaneously in the processing of step S612. The CPU 81 may close each pair of valves that are open simultaneously in the processing of step S616.

In the above-described embodiment, the valves 521, 531, 551, 621, 631, 651, 711, 721, and 911 each open when de-energized and close when energized. Alternatively, the valves 531, 551, 621, 631, 651, 711, 721, and 911 may close when de-energized and open when energized. For example, the valves 531, 621, 631, and 721 may open when de-energized and close when energized, and the valves 551, 651, 711, and 911 may close when de-energized and open when energized.

The printer 1 may be provided with a line head instead of the heads 31 and 32. In this case, for example, the cap 41 may move in the left-right direction or the front-rear direction with respect to the head 31, to a position facing the nozzle surface 311 in the up-down direction. The positional relationship of the pump 541 and the filter 542 may be changed from the above-described embodiment. For example, the pump 541 and the filter 542 may be arranged in the order of the filter 542 and the pump 541 from the point P13 toward the point P12. Similarly, the positional relationship of the valve 521 and the filter 522, the positional relationship of the valve 531 and the filter 532, the positional relationship of the pump 641 and the filter 642, the positional relationship of the valve 621 and the filter 622, and the positional relationship of the valve 631 and the filter 632 may also be changed. Instead of the pair of valves 521 and 531, a single valve may be provided in the flow path 51. Instead of the pair of valves 621 and 631, a single valve may be provided in the flow path 61.

The nozzle surface 311 may be formed by separate surfaces for the nozzle groups W1 and W2 and the nozzle groups W3 and W4. In the nozzle surface 311, the surface provided for the nozzle groups W1 and W2 and the surface provided for the nozzle groups W3 and W4 may be separated from each other on the same plane. For example, a first protruding portion and a second protruding portion may each be protruding downward from the lower surface of the head 31. The nozzle groups W1 and W2 may be provided on the lower surface of the first protruding portion, and the nozzle groups W3 and W4 may be provided on the lower surface of the second protruding portion. In this case, the lower surface of the first protruding portion and the lower surface of the second protruding portion form the nozzle surface 311.

In place of the CPU 81, a microcomputer, application specific integrated circuits (ASICs), a field programmable gate array (FPGA) or the like may be used as a processor. The main processing may be performed as distributed processing by a plurality of the processors. It is sufficient that the non-transitory storage media, such as the ROM 82, the flash memory 84, and the like be a storage medium capable of storing information, regardless of a period of storing the information. The non-transitory storage medium need not necessarily include a transitory storage medium (a transmitted signal, for example). The control program may be downloaded from a server connected to a network (not shown in the drawings) (in other words, may be transmitted as transmission signals), and may be stored in the ROM 82 or the flash memory 84. In this case, the control program may be stored in a non-transitory storage medium, such as an HDD provided in the server.

What is claimed is:

1. A printer provided with a nozzle surface including a first nozzle and a second nozzle, and configured to discharge a first discharge liquid from the first nozzle and discharge a second discharge liquid from the second nozzle, the printer comprising:
a first container configured to store the first discharge liquid;
a first flow path connecting the first container to the first nozzle;
a first valve provided in the first flow path;
a second container configured to store the second discharge liquid;
a second flow path connecting the second container to the second nozzle;
a second valve provided in the second flow path;
a cap configured to form a holding space between the cap and the nozzle surface by surrounding the first nozzle and the second nozzle and contacting the nozzle surface, the cap configured to hold, in the holding space, a holding liquid, the holding liquid including at least one of the first discharge liquid, the second discharge liquid, or a cleaning liquid;
a processor; and
a memory storing computer-readable instructions that, when executed by the processor, instruct the processor to perform a process comprising:
controlling one or both of the first valve and the second valve closed when a holding state and a non-circulating state are established, the holding state being a state in which the cap holds the holding liquid inside the holding space, the non-circulating state being a state in which neither a first circulating state nor a second circulating state is establish, the first circulating state being a state in which the first discharge liquid circulates via the first flow path, the second circulating state being a state in which the second discharge liquid circulates via the second flow path is established.

2. The printer according to claim 1, wherein
the computer-readable instructions stored in the memory further instruct the processor to perform a process comprising:
switching between a first valve state and a second valve state when both the holding state and the non-circulating state are established, the first valve state being a state in which the first valve is closed and the second valve is open, the second valve state being a state in which the first valve is open and the second valve is closed.

3. The printer according to claim 2, wherein
the first container and the second container are each a cartridge;
the first valve and the second valve are each a diaphragm valve or a tube valve; and
the computer-readable instructions stored in the memory further instruct the processor to perform processes comprising:
maintaining the first valve state when it is detected that at least one of a connection between the first container and the first flow path, or a connection between the second container and the second flow path, has been disconnected, when both the holding state and the non-circulating state are established and the first valve state is established; and
maintaining the second valve state when it is detected that at least one of the connection between first container and the first flow path, or the connection between second container and the second flow path, has been disconnected, when both the holding state and the non-circulating state are established and the second valve state is established.

4. The printer according to claim 1, further comprising:
a first sensor configured to detect a first remaining amount of the first discharge liquid stored in the first container; and
a second sensor configured to detect a second remaining amount of the second discharge liquid stored in the second container, wherein
the first valve and the second valve each open when de-energized and close when energized, and
the computer-readable instructions stored in the memory further instruct the processor to perform processes comprising:
controlling one or both of the first valve and the second valve closed when a difference between the first remaining amount detected by the first sensor and the second remaining amount detected by the second sensor exceeds a predetermined threshold value, when both the holding state and the non-circulating state are established, and
controlling both the first valve and the second valve open when the difference between the first remaining amount detected by the first sensor and the second remaining amount detected by the second sensor is less than the predetermined threshold value, when both the holding state and the non-circulating state are established.

5. The printer according to claim 1, wherein
the first valve is provided with a self-holding mechanism configured to close the first valve when energized and configured to hold the first valve closed when de-energized while the first valve is in a closed state, and
the computer-readable instructions stored in the memory further instruct the processor to perform a process comprising:
de-energizing the first valve while the first valve is in the closed state when both the holding state and the non-circulating state are established.

6. The printer according to claim 1, wherein
the computer-readable instructions stored in the memory further instruct the processor to perform processes comprising:
controlling the cap to the holding state while both the first valve and the second valve are open, and
closing one or both of the first valve and the second valve when the non-circulating state is established after the cap has been placed in the holding state.

7. The printer according to claim 1, further comprising:
a third flow path connecting the first container to the first nozzle;
a third valve provided in the third flow path;
a fourth flow path connecting the second container to the second nozzle;
a fourth valve provided in the fourth flow path;
a first pump configured to cause the first discharge liquid to circulate via each of the first flow path and the third flow path; and
a second pump configured to cause the second discharge liquid to circulate via each of the second flow path and the fourth flow path, wherein
the computer-readable instructions stored in the memory further instruct the processor to perform processes comprising:
establishing the first circulating state in which the first discharge liquid is circulated via each of the first flow path and the third flow path by driving the first pump while both the first valve and the third valve are open;
controlling both the second valve and the fourth valve closed when both the holding state and the first circulating state are established;
establishing the second circulating state in which the second discharge liquid is circulated via each of the second flow path and the fourth flow path by driving the second pump while both the second valve and the fourth valve are open; and
controlling both the first valve and the third valve closed when both the holding state and the second circulating state are established.

8. A control method of a printer provided with a nozzle surface including a first nozzle and a second nozzle, and configured to discharge a first discharge liquid from the first nozzle and discharge a second discharge liquid from the second nozzle, the printer comprising:
a first container configured to store the first discharge liquid;
a first flow path connecting the first container to the first nozzle;
a first valve provided in the first flow path;
a second container configured to store the second discharge liquid;
a second flow path connecting the second container to the second nozzle;
a second valve provided in the second flow path; and
a cap configured to form a holding space between the cap and the nozzle surface by surrounding the first nozzle and the second nozzle and contacting the nozzle surface, the cap configured to hold, in the holding space, a holding liquid, the holding liquid including at least one of the first discharge liquid, the second discharge liquid, or a cleaning liquid,
the control method comprising:
controlling one or both of the first valve and the second valve closed when a holding state and a non-circulating state are established, the holding state being a state in which the cap holds the holding liquid inside the holding space, the non-circulating state being a state in which neither a first circulating state nor a second circulating state is establish, the first circulating state being a state in which the first discharge liquid circulates via the first flow path, the second circulating state being a state in which the second discharge liquid circulates via the second flow path is established.

9. A non-transitory computer-readable medium storing computer-readable instructions that, when executed by a computer for controlling a printer, instruct the computer to perform a process, the printer provided with a nozzle surface including a first nozzle and a second nozzle, and configured to discharge a first discharge liquid from the first nozzle and discharge a second discharge liquid from the second nozzle, the printer comprising:
a first container configured to store the first discharge liquid;
a first flow path connecting the first container to the first nozzle;
a first valve provided in the first flow path;
a second container configured to store the second discharge liquid;
a second flow path connecting the second container to the second nozzle;
a second valve provided in the second flow path; and
a cap configured to form a holding space between the cap and the nozzle surface by surrounding the first nozzle and the second nozzle and contacting the nozzle surface, the cap configured to hold, in the holding space, a holding liquid, the holding liquid including at least one of the first discharge liquid, the second discharge liquid, or a cleaning liquid,
the process comprising:
controlling one or both of the first valve and the second valve closed when a holding state and a non-circulating state are established, the holding state being a state in which the cap holds the holding liquid inside the holding space, the non-circulating state being a state in which neither a first circulating state nor a second circulating state is establish, the first circulating state being a state in which the first discharge liquid circulates via the first flow path, the second circulating state being a state in which the second discharge liquid circulates via the second flow path is established.
